(19) United States
(12) Patent Application Publication
(10) Pub. No.: US 2018/0360177 A1
(43) Pub. Date: Dec. 20, 2018

(54) ROBOTIC SUITCASE

(71) Applicant: Travelmate Robotics Inc., Las Vegas, NV (US)

(72) Inventors: Leonid Kovtun, Las Vegas, NV (US); Taras Yermakov, Kiev (UA); Leonid Ryzhenko, San Francisco, CA (US)

(21) Appl. No.: 15/725,656

(22) Filed: Oct. 5, 2017

Related U.S. Application Data
(60) Provisional application No. 62/520,436, filed on Jun. 15, 2017.
(60) Provisional application No. 62/530,744, filed on Jul. 10, 2017.

(51) Int. Cl. A45C 5/14; A45C 5/03; A45C 15/06; G05D 1/00; G05D 1/02

(52) U.S. Cl. CPC A45C 5/14; A45C 5/03; A45C 15/06; G05D 1/0285; G05D 1/0255; G05D 1/0242; G05D 1/0088

(57) ABSTRACT

A robotic suitcase is disclosed that can autonomously follow a traveler while providing him or her with additional smart functionalities. The robotic suitcase may be communicatively connected with a mobile user device via a wireless connection so that the robotic suitcase follows the mobile device.

### PRIORITY CLAIM

The present application claims priority to Provisional Patent Application No. 62/520,463, filed Jun. 15, 2017, and Provisional Patent Application No. 62/530,744 filed Jul. 10, 2017, both of which applications are incorporated herein in there entireties.

### BACKGROUND

Travelers often need to carry a lot with them, especially when travelling long distances for long periods of time. They typically pack their belongings into suitcases, including smaller suitcases that they may carry onto the plane with them, as well as larger suitcases that need to be checked and stored in the plane's cargo space. An individual traveler may often have to transport multiple suitcases, bags, and other items at various moments during their travels, while simultaneously perform tasks such as checking in, getting past security, boarding, holding conversations, making payments, and supervising pets and children. The complexity of such inventory management further increases when they not only have to look after their own luggage, but also those of their family and friends. During these potentially stressful moments, a traveler is more likely to mishandle items or otherwise make mistakes that may result in lost luggage, damaged property, or injury to himself and others around him.

### DESCRIPTION OF THE DRAWINGS

FIGS. 1a and 1b illustrate a front view of the robotic suitcase.

FIGS. 2a and 2b illustrate a back view of the robotic suitcase.

FIGS. 3a and 3b illustrate a top view of the robotic suitcase.

FIGS. 4a and 4b illustrate a bottom view of the robotic suitcase.

FIGS. 5a and 5b illustrate a left view of the robotic suitcase.

FIGS. 6a and 6b illustrate a right view of the robotic suitcase.

FIGS. 7a to 10b illustrate perspective views of the suitcase described in FIGS. 1 to 6.

FIGS. 11, 12a-12b and 13 illustrate 3D renderings of the robotic suitcase, highlighting the LED light strips.

FIGS. 11a-b illustrate a view of the robotic suitcase with a back cover removed.

FIG. 14 illustrates that a camera may be mounted onto the handle of the robotic suitcase.

FIG. 15 illustrates an embodiment of the suitcase highlighting various features.

FIGS. 16 to 17 illustrate exemplary dimensions of the suitcase according to one embodiment of the present technology.

FIGS. 18 to 20 illustrate the positioning of sensors on the suitcase 100 according to an embodiment of the present technology.

FIG. 21 illustrates a smart-lock and other items on a panel of the suitcase according to embodiments of the present technology.

FIG. 22 illustrates a top portion of the suitcase folding outward so that items may be placed within the suitcase.

FIGS. 23 to 28b illustrate the power transmission system for transferring power from a motor to one or both of the omni wheels.

FIG. 29 illustrates an embodiment of the present technology comprising a robotic companion suitcase system.

FIG. 30 illustrates an exemplary computer from FIG. 29 according to an embodiment of the present technology.

FIG. 31 illustrates an exemplary user device according to an embodiment of the present technology.

FIG. 32 is a view of the robotic suitcase including a camera for capturing images.

FIG. 33 is a view of the robotic suitcase including conventional wheels.

### DETAILED DESCRIPTION

The present technology is directed to methods, devices, and systems involving a robotic suitcase that can autonomously follow a traveler while providing him or her with additional smart functionalities. The robotic suitcase may be communicatively connected with a mobile device via a wireless connection so that the robotic suitcase follows the mobile device. The traveler may also configure the robotic suitcase via the wireless device to control its functionalities. Given these features, the robotic suitcase thus provides a more comfortable travel experience for its user. In addition to being a travel companion, the same functionalities of the robotic suitcase may also assist a user during everyday use, such when the user is going to their workplace, their school, or a shopping center. Similarly, the same functionalities of the robotic suitcase may also have applications outside of being a travel companion, including applications as a shopping assistant, or other applications in sports, medical settings, and security.

The present technology comprises hardware and software components. At a high level, these components may be grouped into functional categories. Hardware components include those directed to the suitcase's overall structure and appearance, power, processing capabilities, sensors, wireless communication, locomotion, and peripherals. Software components include those directed to processing sensor data, controlling the robot's movements, communicating with the user device, and controlling peripheral functionalities.

General Structure and Features

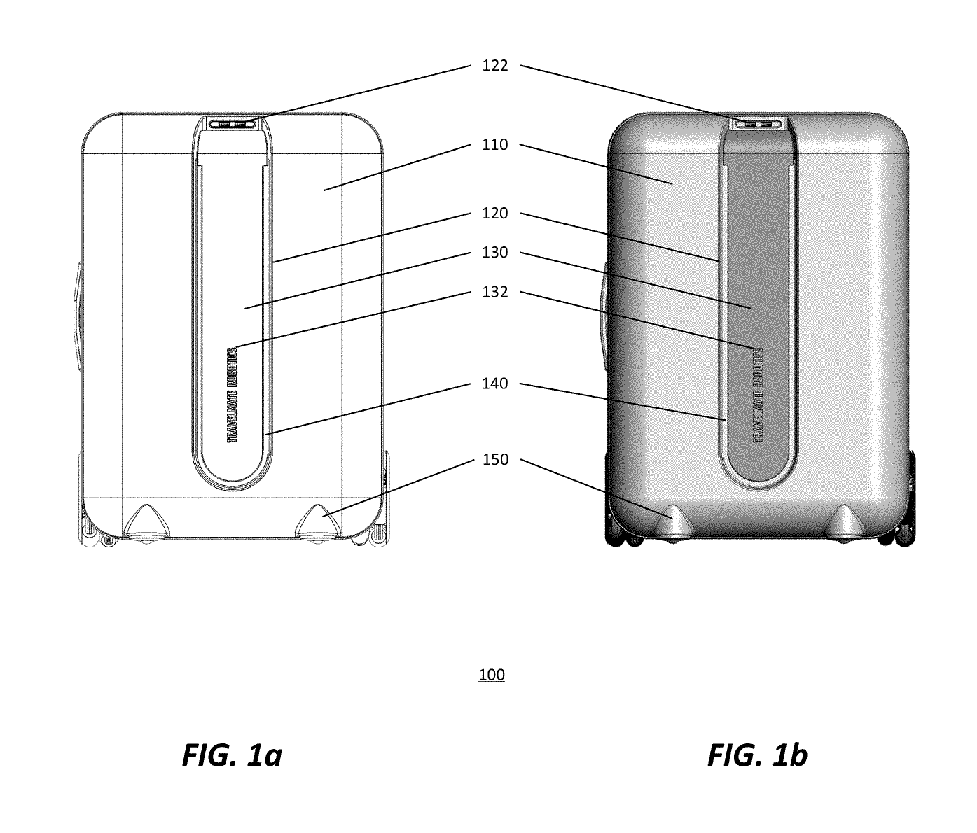

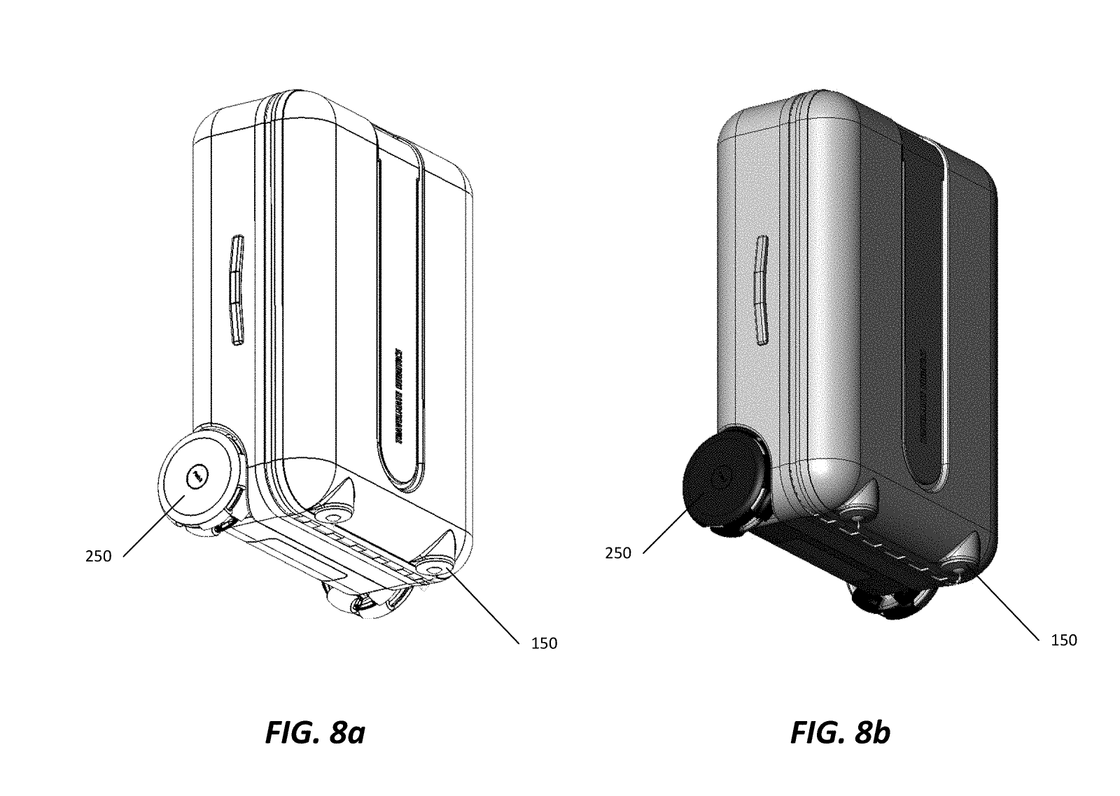

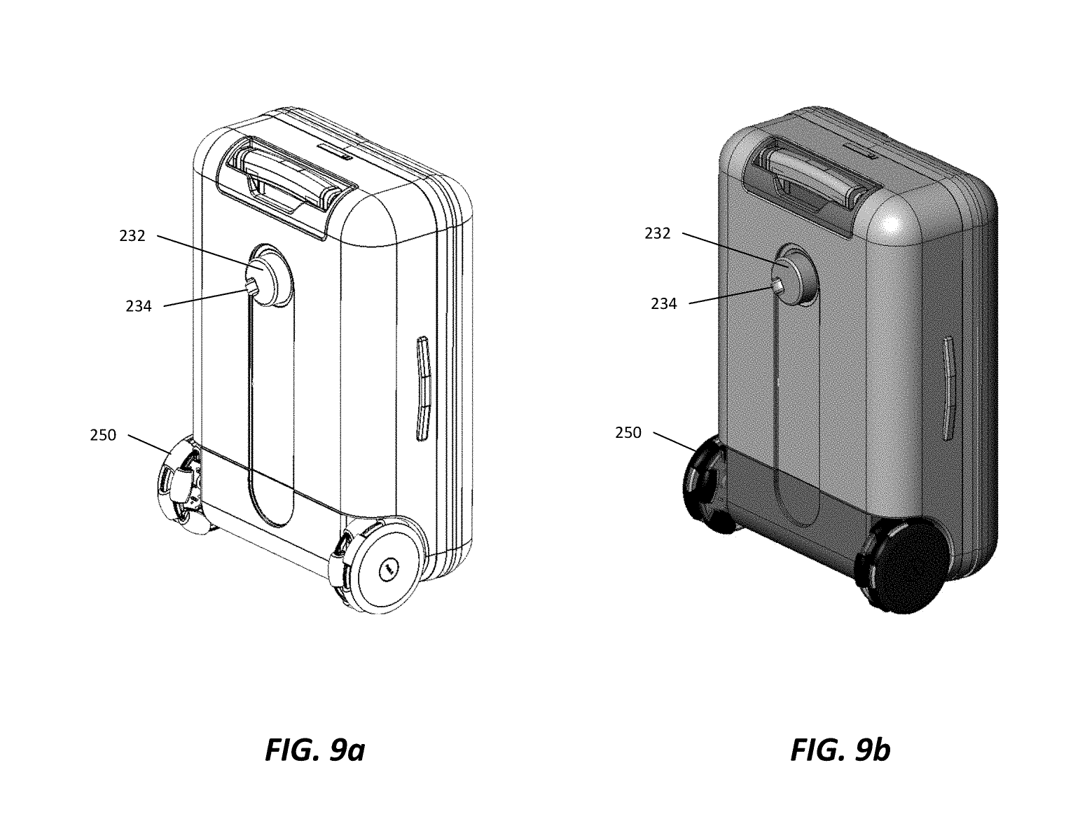

FIGS. 1a to 10 illustrate various perspectives of an embodiment of the present technology involving a robotic suitcase 100. Directional language, including words such as “front, back, top, bottom, left, and right,” are used herein to describe the robotic suitcase 100 relative to an orientation of the suitcase 100 where it is standing vertically upright such that the “TRAVELMATE ROBOTICS” logo 132 is facing the viewer, as shown in FIG. 1b.

In one embodiment, the robotic suitcase 100 may be made of ABS and Polycarbonate plastic material. The suitcase 100 may be made of other combinations of one or more materials in alternative embodiments. The suitcase 100 has a generally rectangular shape with rounded edges and corners. Accordingly, the suitcase 100 has six surfaces, including a front surface 110, back surface 210, top surface 310, bottom surface 410, left surface 510, and right surface 610.

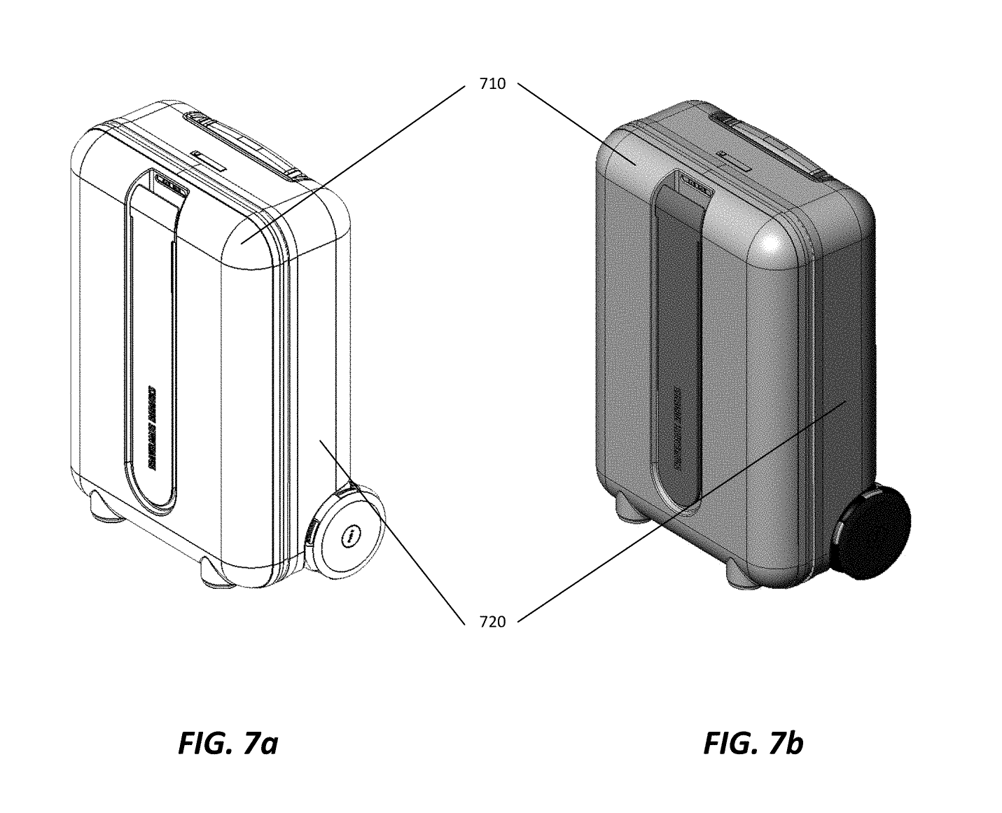

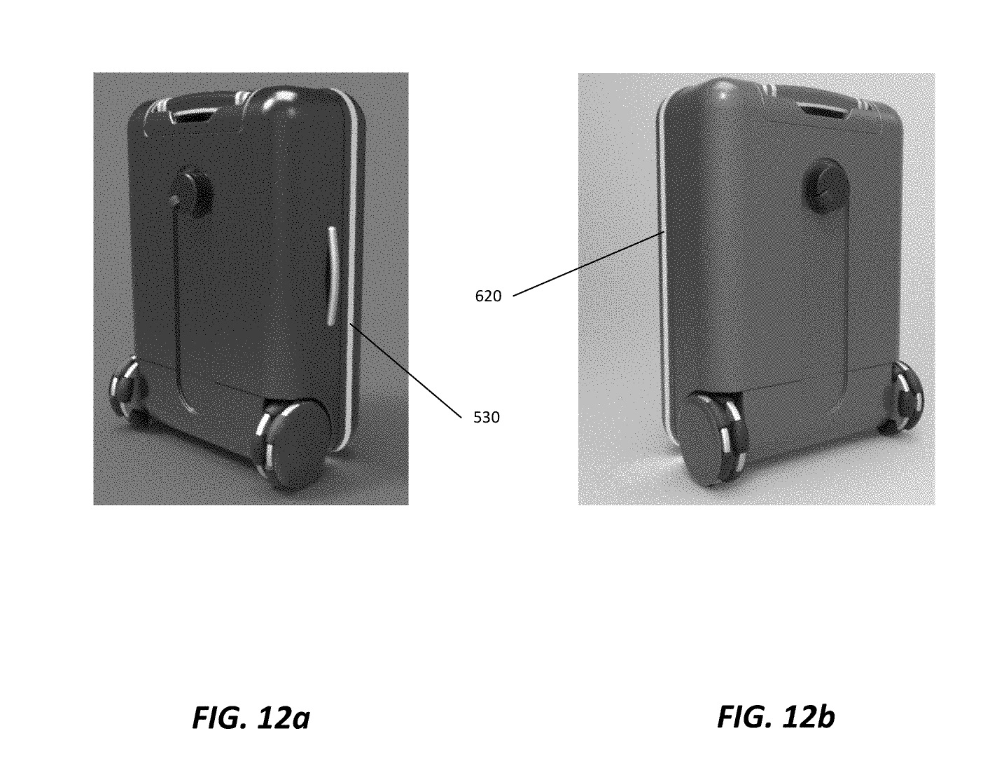

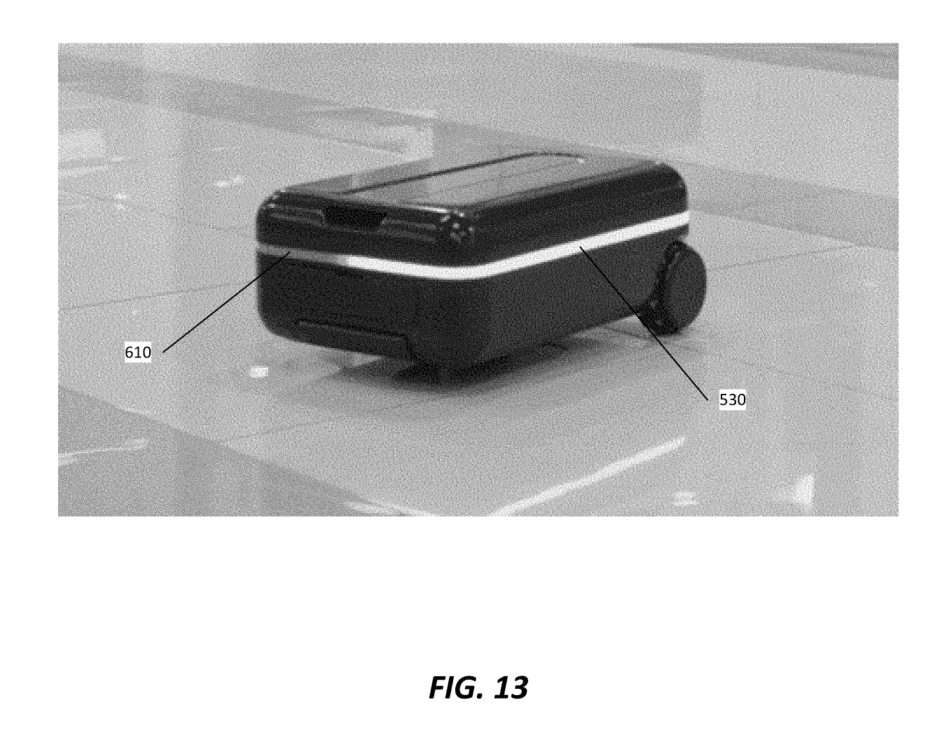

The suitcase comprises two separable sections (as shown and labelled in FIG. 7): a front section 710 that serves as a cap 710 of the suitcase and a back section 720 that serves as a body 720 of the suitcase. The suitcase 100 has two operating modes for how the suitcase 100 can move autonomously: a vertical travel mode (as shown in FIG. 12, for example), where the suitcase moves while standing upright, and a horizontal travel mode (as shown in FIG. 13, for example), where the suitcase moves while lying flat in a horizontal orientation. In the vertical travel mode, the suitcase 100 may stand vertically upright so that the front surface 110 is facing in a forward-moving direction. In the horizontal travel mode, the suitcase may lie horizontally so that the front surface is facing upwards and the top surface 310 is facing in a forward-moving direction.

FIGS. 1a and 1b illustrate a front view of the robotic suitcase 100, showing its front surface 110, according to one embodiment of the present technology. The front surface 110 of the suitcase 100 may comprise a recessed region 120. The recessed region 120 may comprise two USB ports 122 located at a top end of the recessed region and near the top surface 310 of the suitcase 100. The recessed region 120 may further comprise a front LED light strip 140 that is partially covered and protected by a front panel 130. The front panel 130 is shown with a logo 132 printed on its surface, but the logo may be replaced by other text or omitted in further embodiments. By positioning the front light strip 140 within the recessed region, the front light 140 is recessed into the front surface 110 and therefore better protected from potential damage. A top portion of the front panel 130 may include a hand grip that a traveler may grab onto at the top end of the panel near the top surface 110 by inserting his or her fingers in between the panel 130 and the recessed region 120.

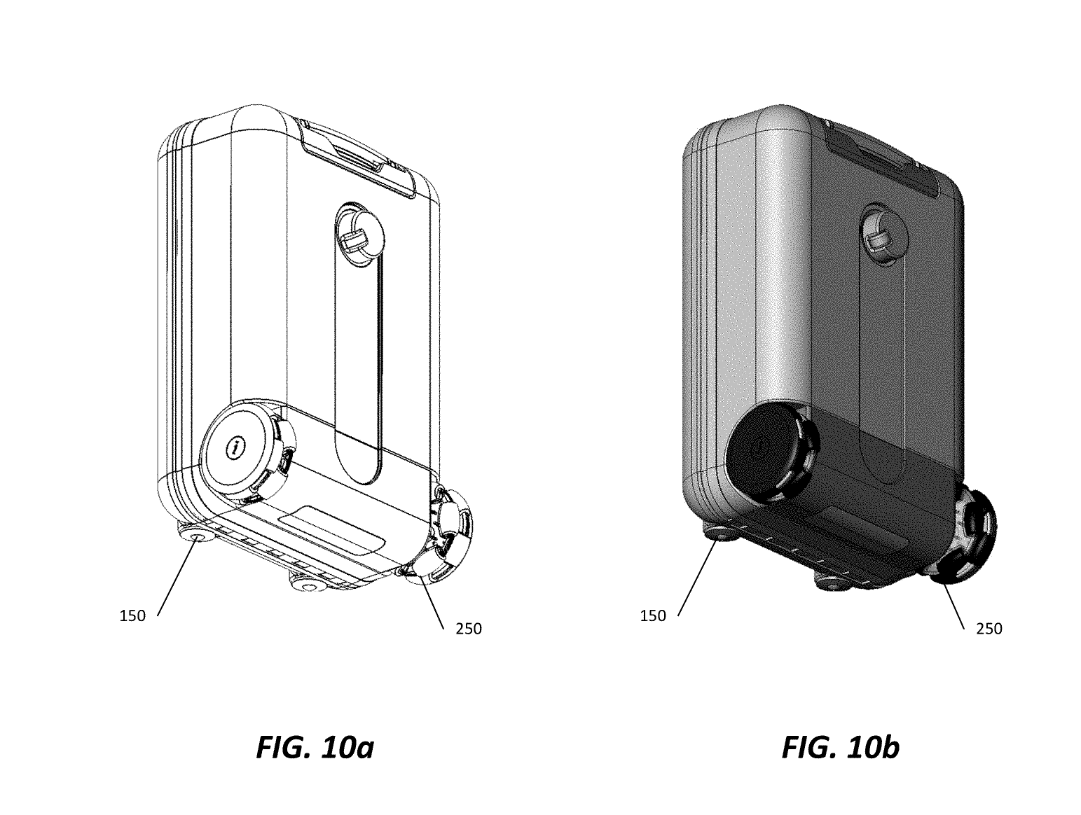

The front surface may further comprise two front roller wheels 150 located near the bottom surface 410. The front roller wheels 150 may engage the floor and help maintain balance and enable locomotion while the robotic suitcase 100 is moving in the vertical travel mode. The front roller wheels 150 may comprise a spherical rolling element (as depicted in FIGS. 1a and b and FIG. 10, for example) so that the front roller wheels 150 can roll in any direction.

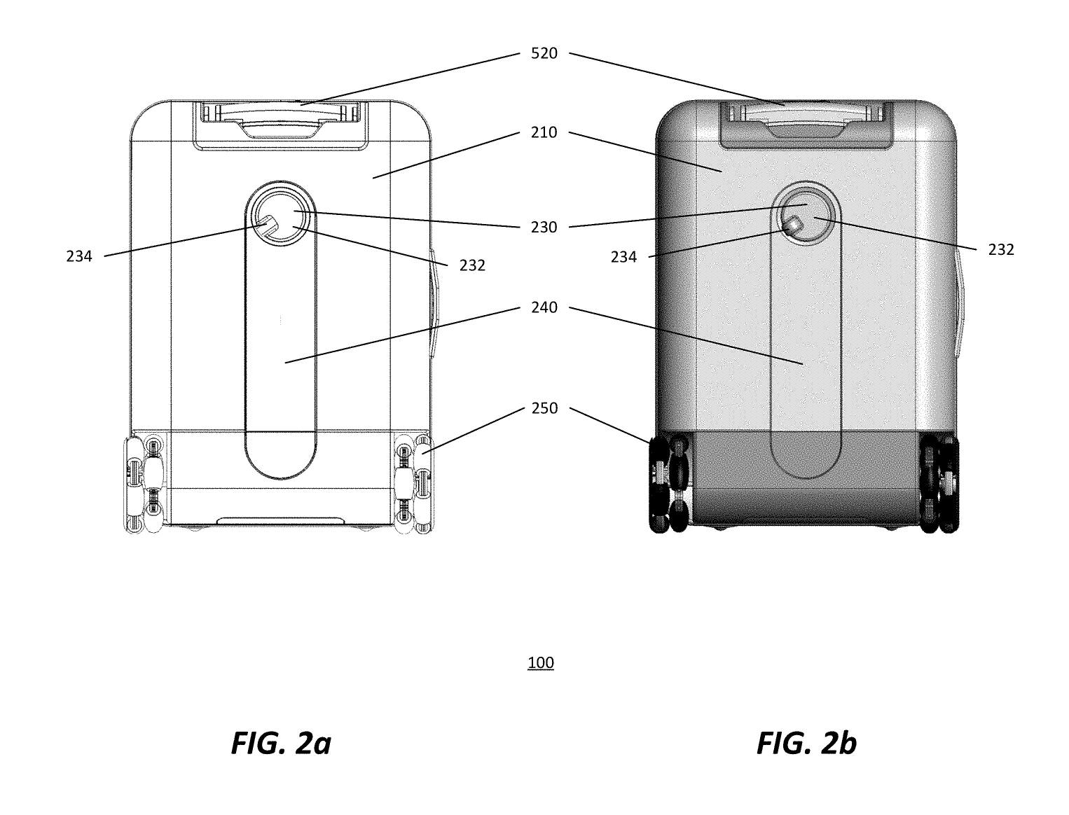

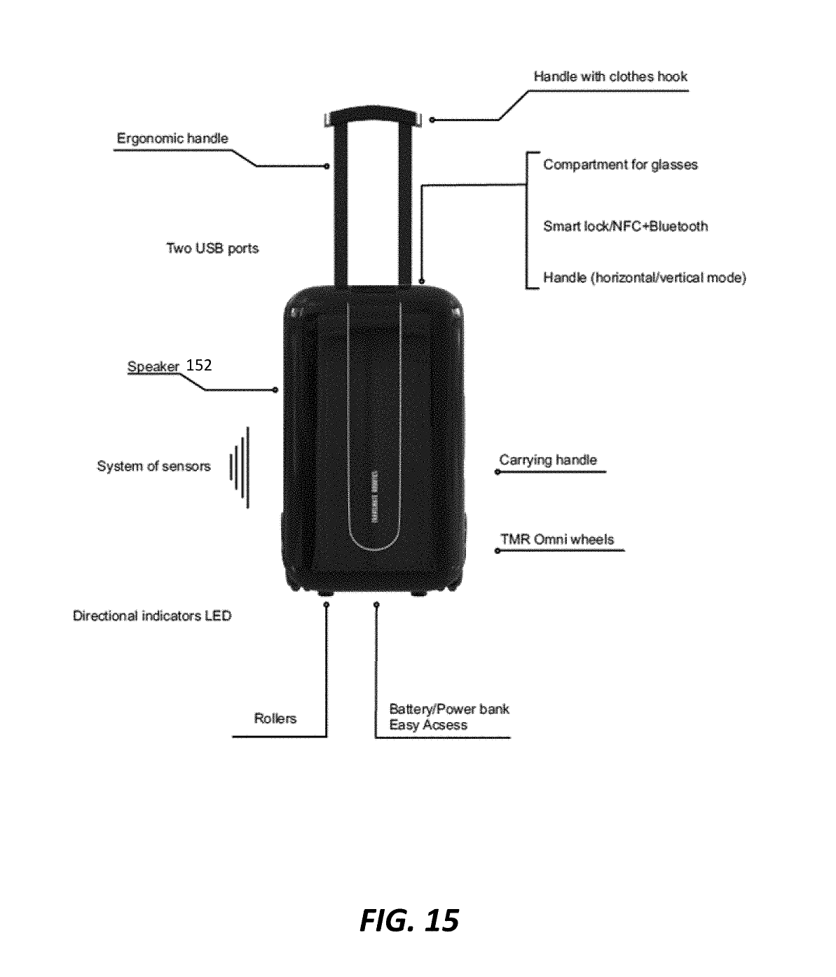

FIGS. 2a and 2b illustrate a back view of the robotic suitcase 100, showing its back surface 210, according to one embodiment of the present technology. The back surface 210 may comprise a retractable handle 520, a recessed region 240 in the center of the back surface 210, and two motorized omni wheels 250. The retractable handle 520 may have grooves on either side (as shown in FIG. 15) that may allow clothe hangers to hang off of the grooves when the retractable handle 520 is fully extended.

The recessed region 240 may comprise a back support wheel assembly 230. The back support wheel assembly 230 may engage the floor and help maintain balance and enable locomotion while the robotic suitcase 100 is moving in the horizontal travel mode (as shown in FIG. 13, for example). In one embodiment, the back support wheel assembly 230 includes a disc 232 that may rotate about an axis perpendicular to the back surface 210 of the suitcase 100. At the edge of the disc 232 is mounted a wheel, or caster, 234 that may rotate in a plane through the radial center of the disc 232. The rotational plane of the wheel 234 may also be perpendicular to the back surface 210 of the suitcase. The combination of the disc 232 and the wheel 234 therefore allows the back support wheel assembly 230 to rotate in any direction around a plane that is parallel to the back surface 210.

The two motorized omni wheels 250 are discussed in greater detail in a related provisional application 62/520,463, filed Jun. 15, 2017. Details contained within that application are not repeated herein. The geometry and operation of the omni wheels allow for easier movement over uneven terrain and locomotion along a surface in any direction.

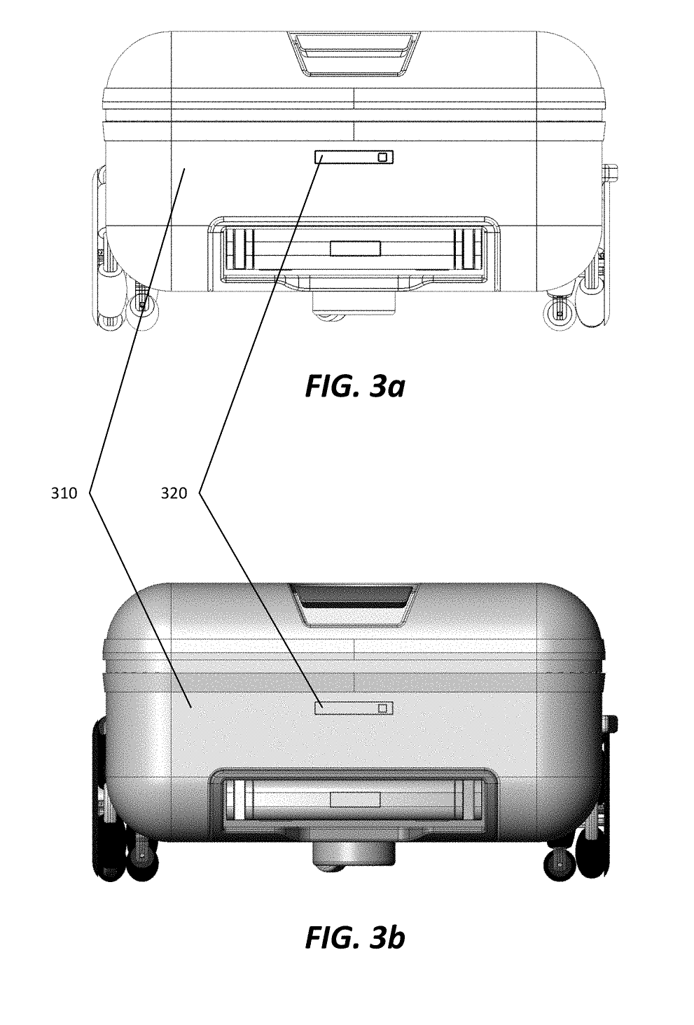

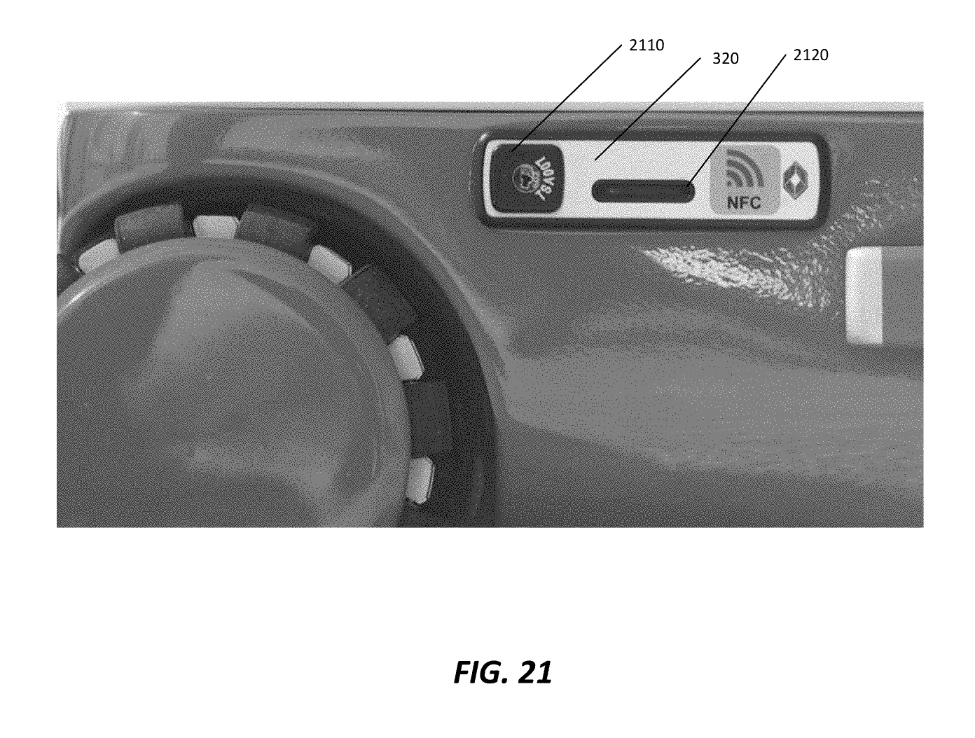

FIGS. 3a and 3b illustrate a top view of the robotic suitcase 100, showing its top surface 310, according to one embodiment of the present technology. The top surface 310 may comprise a smart lock 320 at the center of the top surface 310. A closer view of an implementation of the smart lock 320 is depicted in FIG. 21, which illustrates an embodiment where the smart lock 320 is placed on the left surface 510 of the suitcase 100 rather than on the top surface 310. In one embodiment, the smart lock 320 comprises a TSA mechanical lock 2110 and a Bluetooth communications device 2120 that allows the smart lock to be controlled wirelessly by a mobile user device, such as a smart phone.

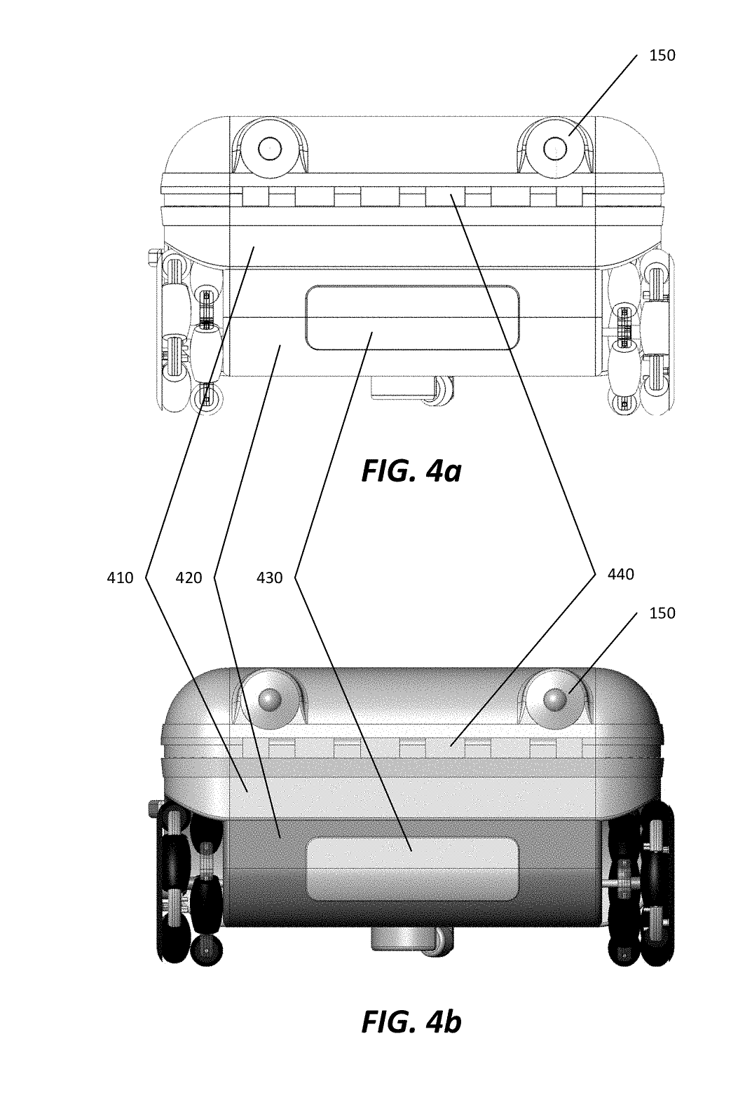

FIGS. 4a and 4b illustrate a bottom view of the robotic suitcase 100, showing its bottom surface 410, according to an embodiment of the present technology. The bottom surface 410 may comprise an enclosed compartment 420 (shown as the dark grey region in FIG. 4b) that houses the motors, the power transmission system, the battery 430, and a computer used for controlling the robotic suitcase 100. In one embodiment, the battery 430 may be detached from the suitcase 100, such as for example when passing through a security screen or for separate recharging.

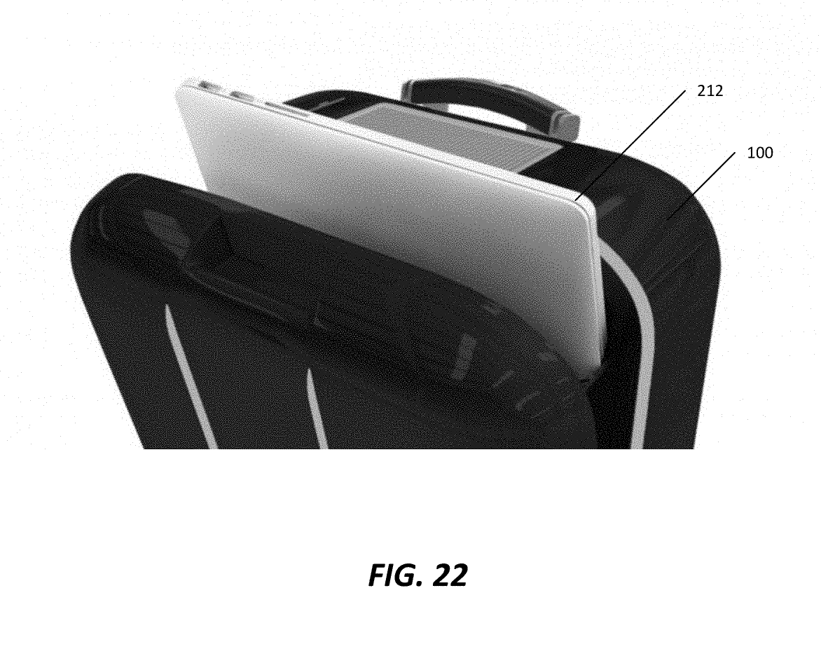

The bottom surface 410 further comprises hinges 440 that join the suitcase cap 710 and body 720. In one embodiment, there may be six hinges 440 placed on the bottom surface 410. The number of hinges 440 may be different in other embodiments. The hinges 440 and the smart lock 320 on the top surface 310 allow the cap 710 of the suitcase 100 to partially open at the top surface 310, as shown in FIG. 22. This makes it convenient for the traveler to open the suitcase 100 from the top surface to place a laptop or another item 212 into the suitcase without having the contents of the suitcase 100 fall out from the sides. Because the opening is on the top surface 310, the traveler can open the suitcase 100 while it is in an upright position, and therefore does not have to bend down to open the suitcase from one side.

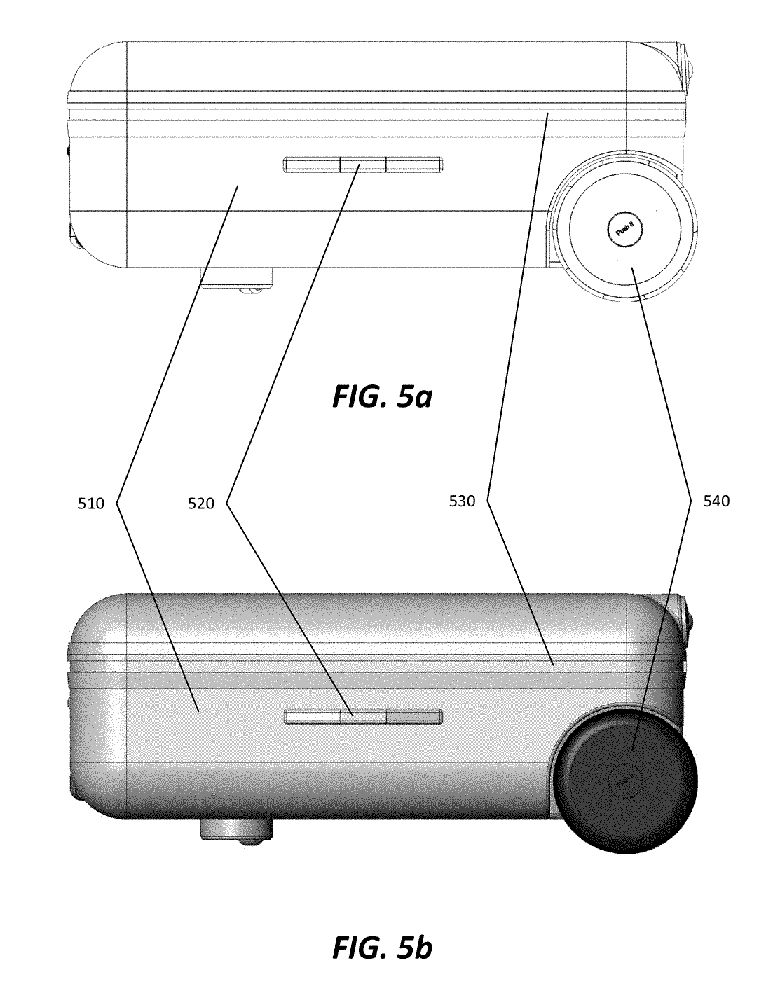

FIGS. 5a and 5b illustrate a left view of the robotic suitcase 100, showing its left surface 510, according to an embodiment of the present technology. The left surface 510 comprises a carrying handle 520 and a left LED light strip 530. In one embodiment, the left light strip 530 extends from the middle of the top surface 310, along the entire length of the left surface 510, and ends at the hinges 440 on the bottom surface 410. The left surface 510 further comprises a cover 540 for the omni wheels 250. In one embodiment, in addition to providing protection for the omni wheels 250, the cover 540 also acts as a button. When the traveler pushes the cover 540, the omni wheels 250 lock so that the suitcase 100 would not slip when standing on an inclined surface or to otherwise prevent locomotion. When the cover 540 is pushed a second time, omni wheels 250 unlock to restore mobility to the omni wheels once again.

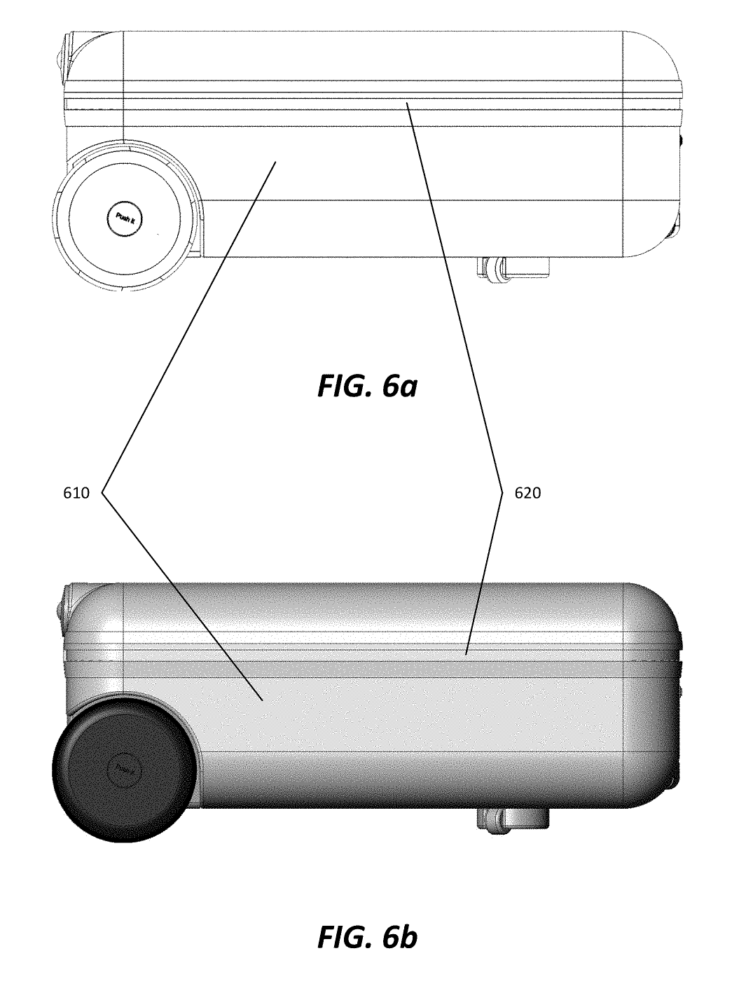

FIGS. 6a and 6b illustrate a right view of the robotic suitcase 100, showing its right surface 610, according to an embodiment of the present technology. The right surface 610 comprises a right LED light strip 620 that may be symmetrical to the left LED light strip 530. The right light strip 620 extends from the middle of the top surface 310, along the entire length of the right surface 610, and ends at the hinges 440 of the bottom surface 410.

FIGS. 7 to 10 illustrate perspective views of the suitcase 100 described in FIGS. 1 to 6.

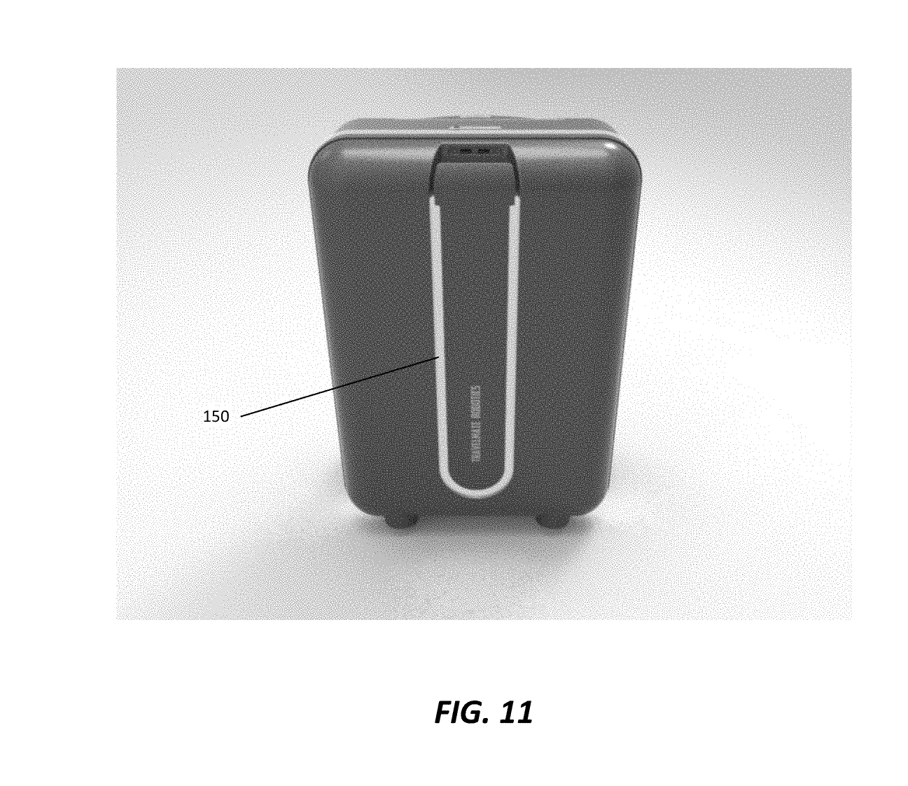

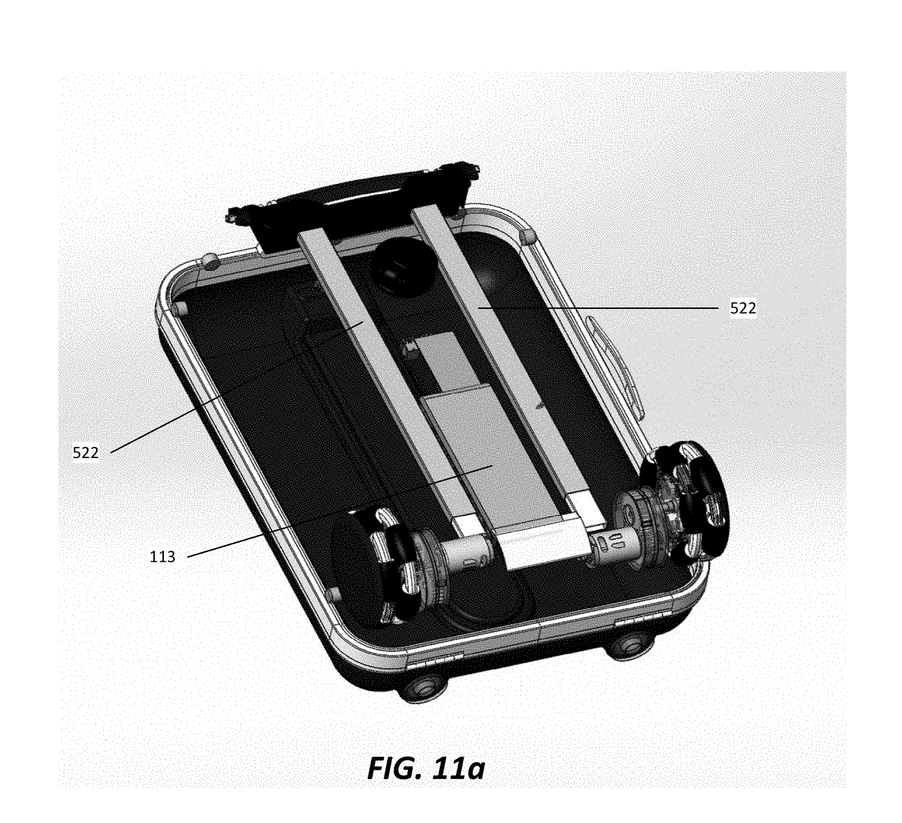

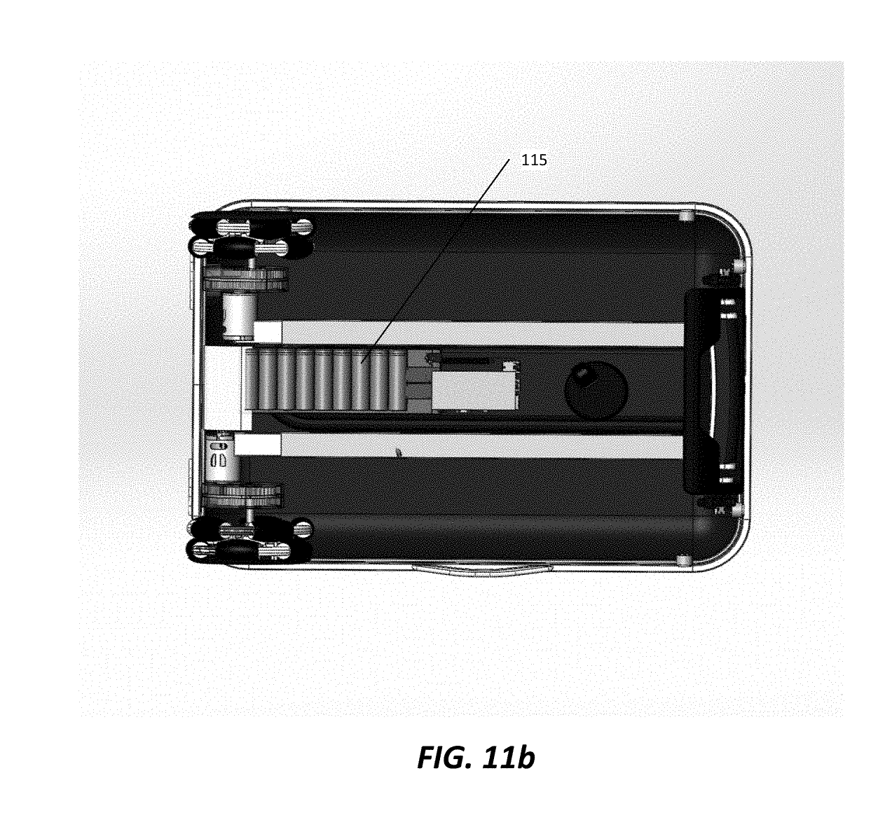

FIGS. 11 and 12-13 illustrate 3D renderings of the robotic suitcase 100, highlighting the LED light strips 150, 530, and 620, according to an embodiment of the present technology. The three lights 150, 530, and 620 may be configured and controlled wirelessly via a user device. For example, in one embodiment, the traveler may set the brightness and color of the lights 150, 530, and 620. The front light 150 may indicate the power level of the battery 430. In one embodiment, the front light 150 stays constant until battery power levels are low, in which case the front light 150 would blink to indicate that the battery 430 is almost depleted. In other embodiments, the battery power level may be indicated by the brightness and/or color of the front light 150. FIG. 13 illustrates how the left 530 and right LED light strips 620 connect at the middle of the top surface 310, and that the two lights can be activated separately. In one embodiment, the left light 530 may blink when the robot is turning towards a left direction. Similarly, the right light 620 may blink when the robot is turning towards a right direction.

FIG. 11a-b illustrate a view of the robotic suitcase 100 with a back cover removed. As shown the robotic suitcase may include a removable power pack 113 comprising rechargeable power cells 115. The retractable handle 520 may be affixed telescoping support arms 522 to allow the handle to extend out away from, and retract toward, the robotic suitcase 100.

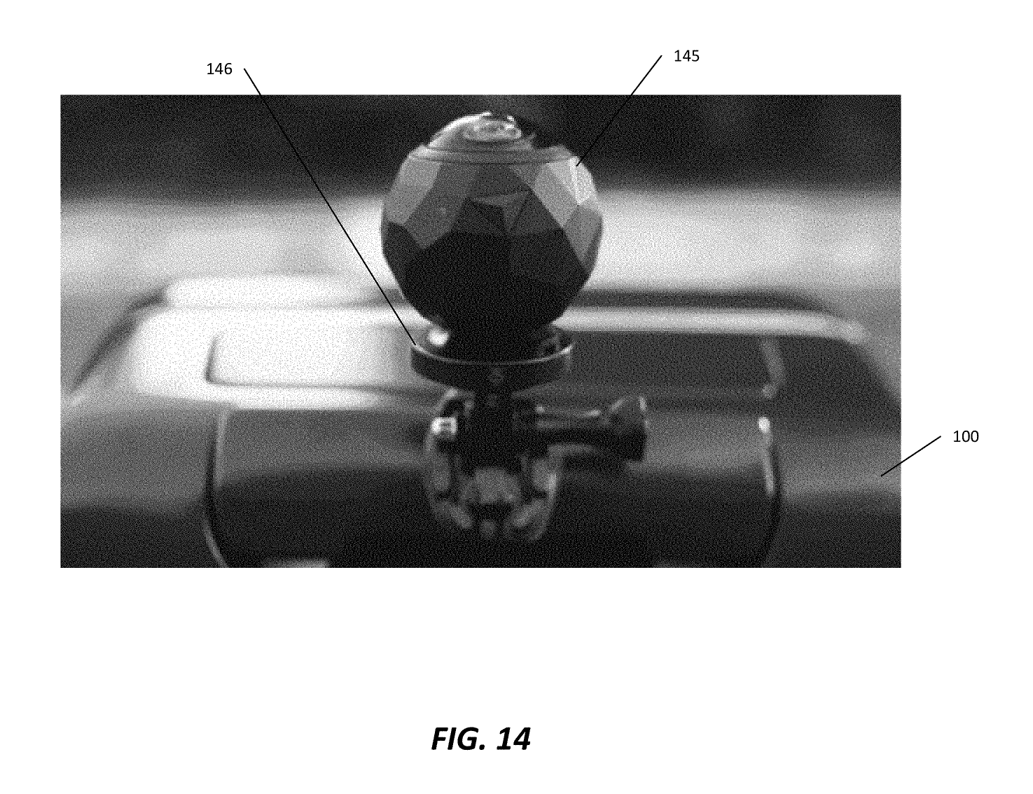

FIG. 14 illustrates that a camera 145, such as a VR camera, may be mounted onto the handle of the robotic suitcase 100 via a camera holder 146.

FIG. 15 illustrates an embodiment of the suitcase 100 and highlights its various features. As shown in FIG. 15, the suitcase may include a speaker 152 for emitting sounds. In one embodiment, the speaker can be used to provide alert other people, pets, or robotic entities of its presence. In one embodiment, the speaker may generate a constant background noise. In other embodiments, the speaker may play a high-pitched warning signal or an audio message. The speaker may also emit sounds to communicate information about the suitcase's status, such as battery level.

The suitcase 100 may also include a wireless communications device, such as a Bluetooth device, for communicating with, and following, a mobile user device such as a smart phone. The mobile user device may be other computing devices in further embodiments including for example a tablet, a smart watch, a personal digital assistant a laptop and a smart camera. The mobile user device may alternatively be an electronic control device dedicated to the robotic suitcase 100 (i.e., has no uses other than controlling the robotic suitcase). In a further embodiment, the user device may be incorporated into an item of jewelry or clothing worn by a user. The suitcase 100 further include antennas to extend the range of the wireless communication devices so that the suitcase 100 may maintain communication with the user device at longer distances. The suitcase 100 may further include an antenna extender, which may be used to further extend the range of the wireless communications device.

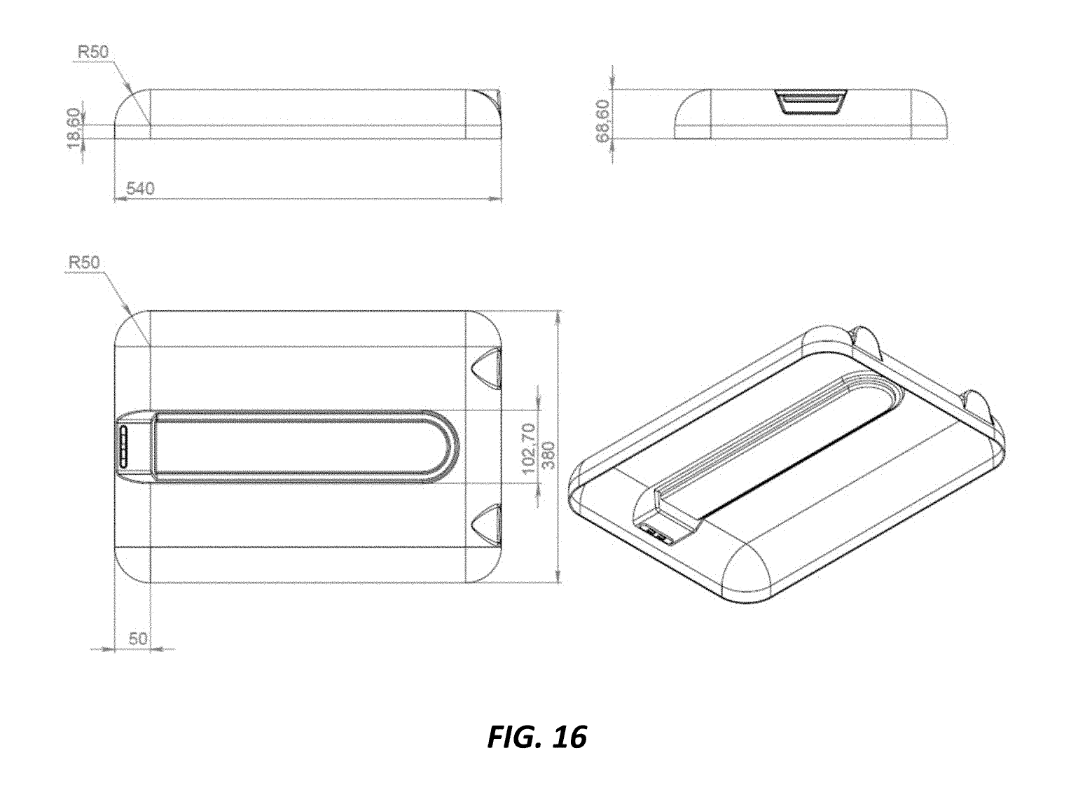

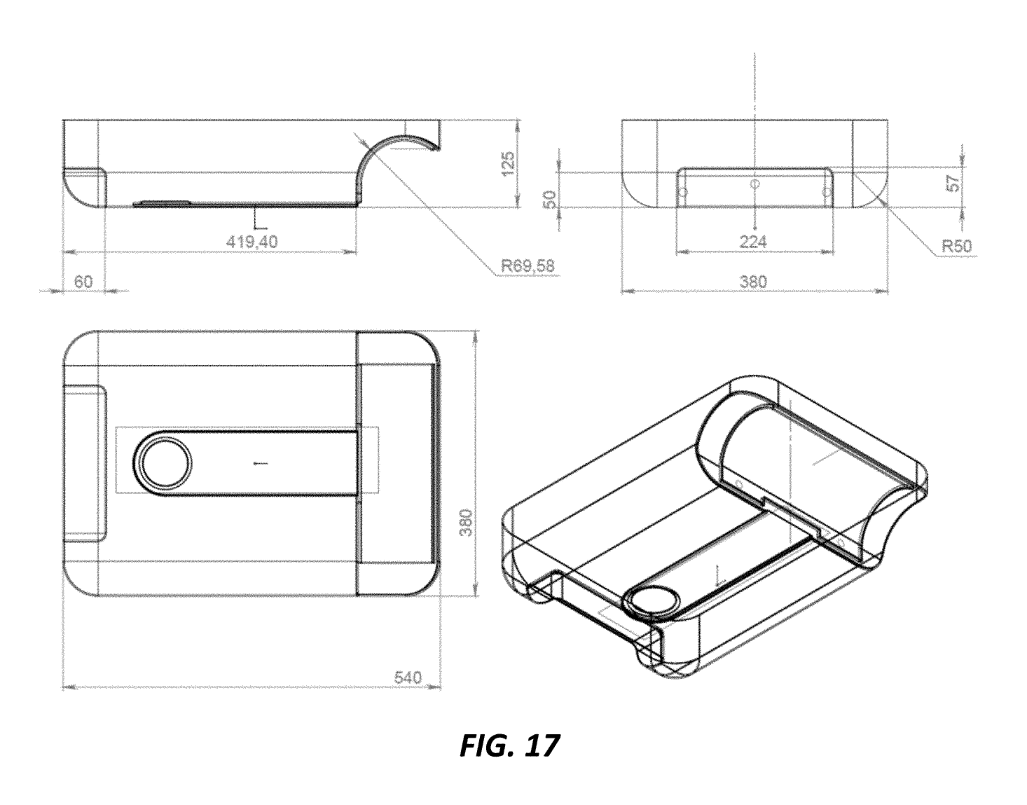

FIGS. 16 to 17 illustrate exemplary dimensions of the suitcase 100 according to one embodiment of the present technology.

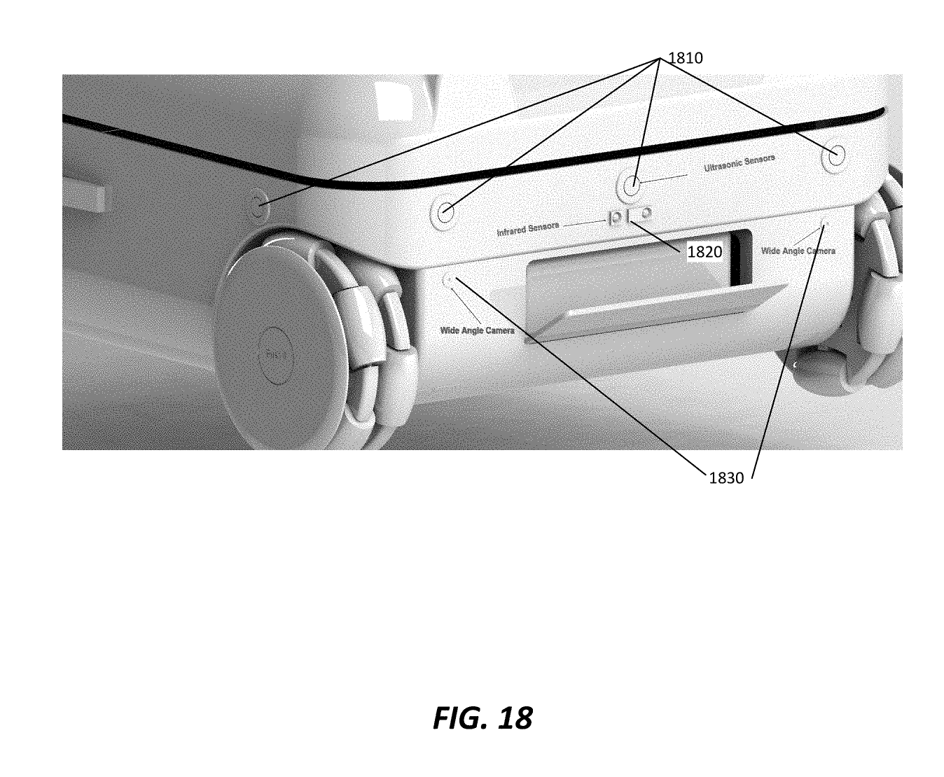

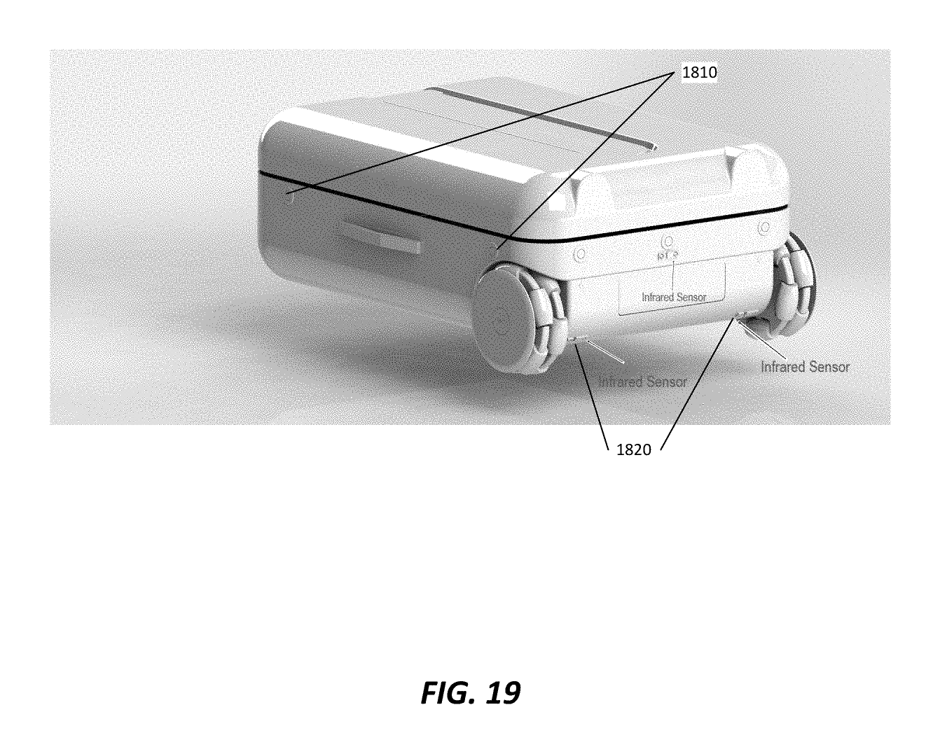

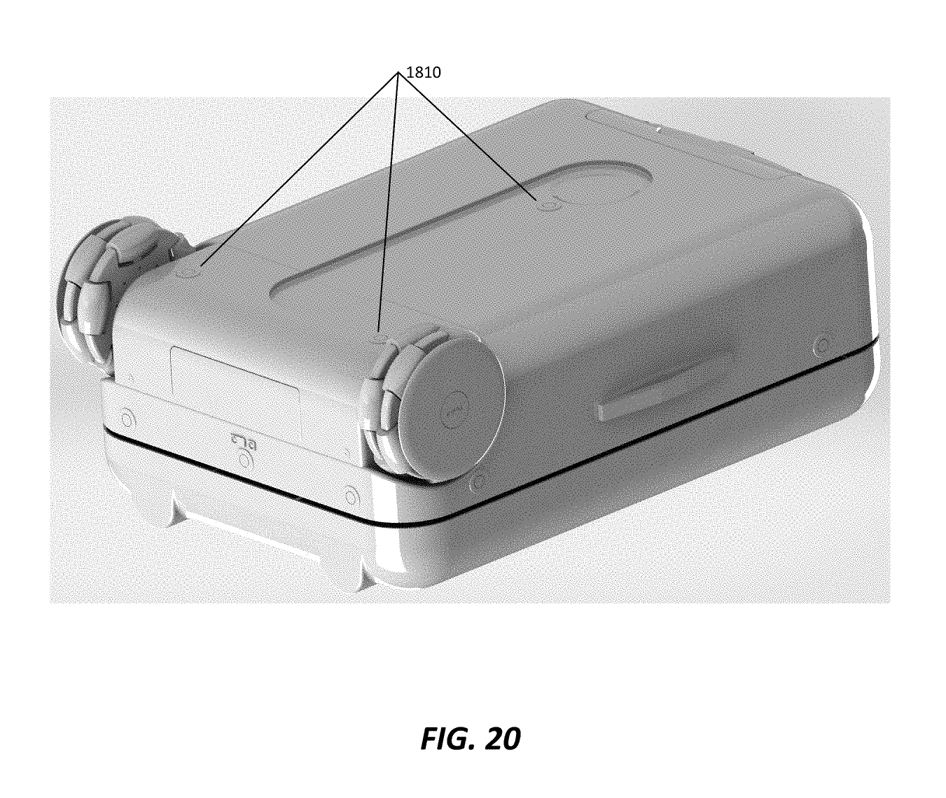

FIGS. 18 to 20 illustrate the positioning of sensors on the suitcase 100 according to an embodiment of the present technology. As shown in FIG. 18, the bottom surface 410 may further comprise three ultrasonic sensors 1810, an infrared sensor 1820, and two wide angle cameras 1830. As shown in FIG. 19, the bottom surface 410 may further comprise two additional infrared sensors 1820 closer towards the back surface 210. In addition, the left surface may comprise two additional ultrasonic sensors 1810. The right surface 610 may also include two additional ultrasonic sensors 1810 having positions symmetrical or similar to the positions for the ultrasonic sensors 1810 on the left surface 510. The back surface 210 further includes three additional ultrasonic sensors 1810. Although not depicted in the drawings, the front 110 and top 310 surfaces may further include additional ultrasonic 1810, infrared 1820, and optic 1830 sensors (such as wide-angle cameras). It is understood that other embodiments may have fewer or more of the above mentioned sensors, and may arrange the sensors differently at different positions. Altogether, the suitcase 100 may use any combination of one or more of these sensors to gather information about the surrounding environment.

The suitcase 100 may also include other types of sensors or devices for gathering information about its surroundings, such as touch sensors, speed sensors, accelerometers, and gyroscopes. The suitcase 100 may also have a GPS device for gathering data about the suitcase's location so that a traveler may track the location of the suitcase 100 if it gets lost. The suitcase 100 may also have a built in scale to automatically indicate the weight of the suitcase 100, so that the traveler would not have to manually weigh the suitcase 100.

Locomotion

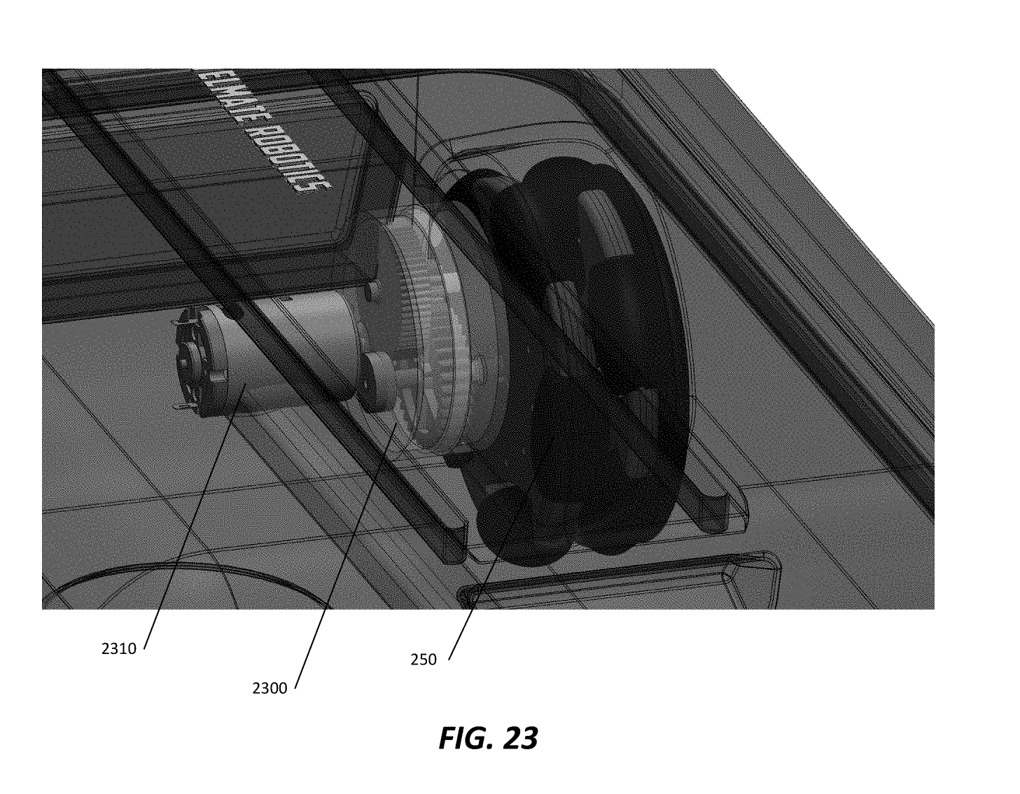

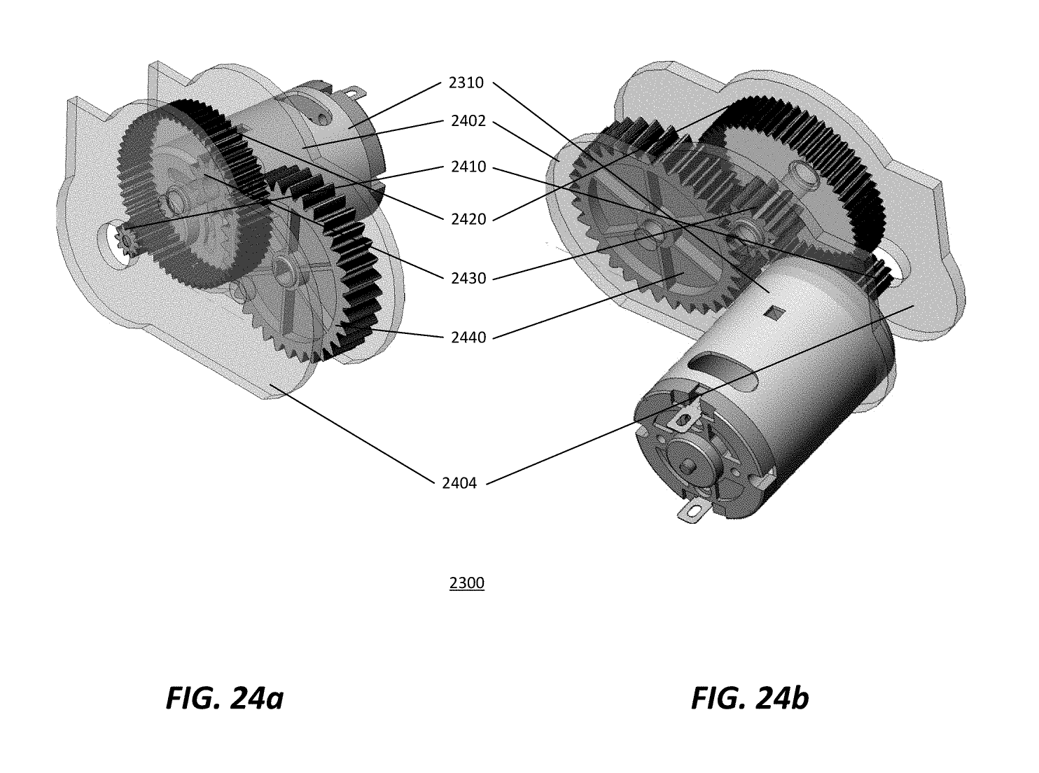

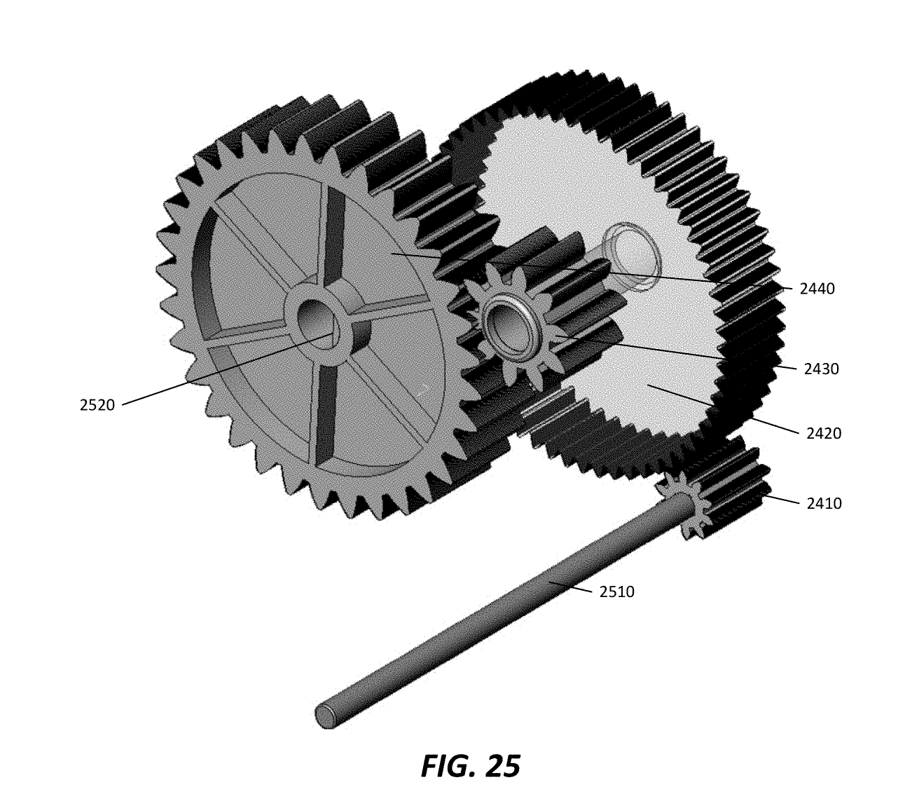

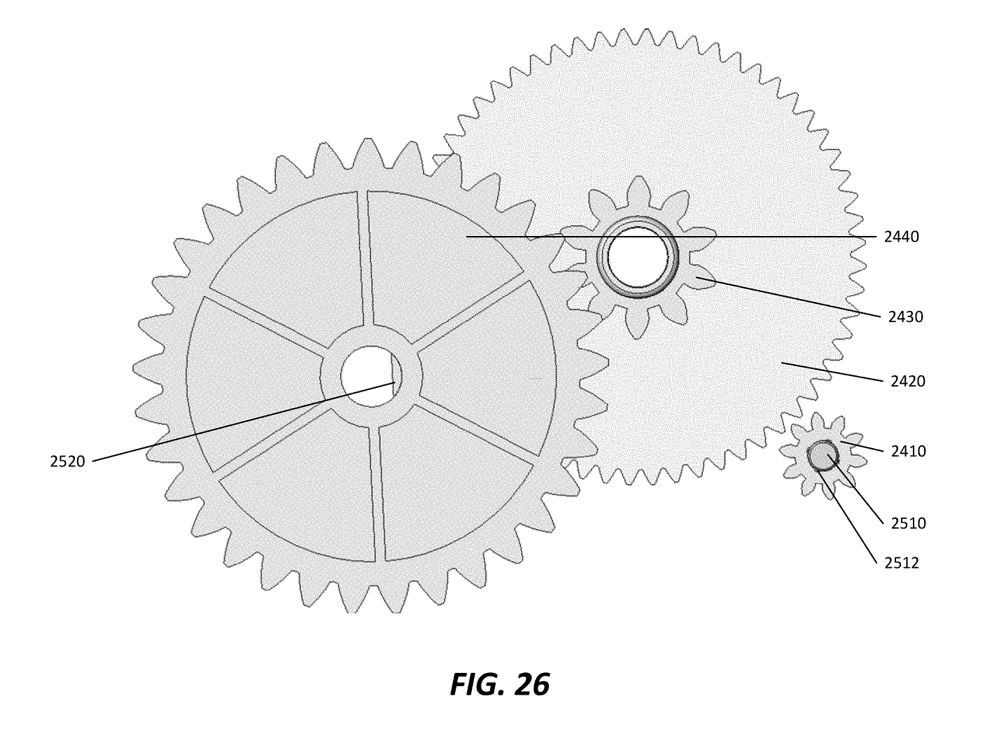

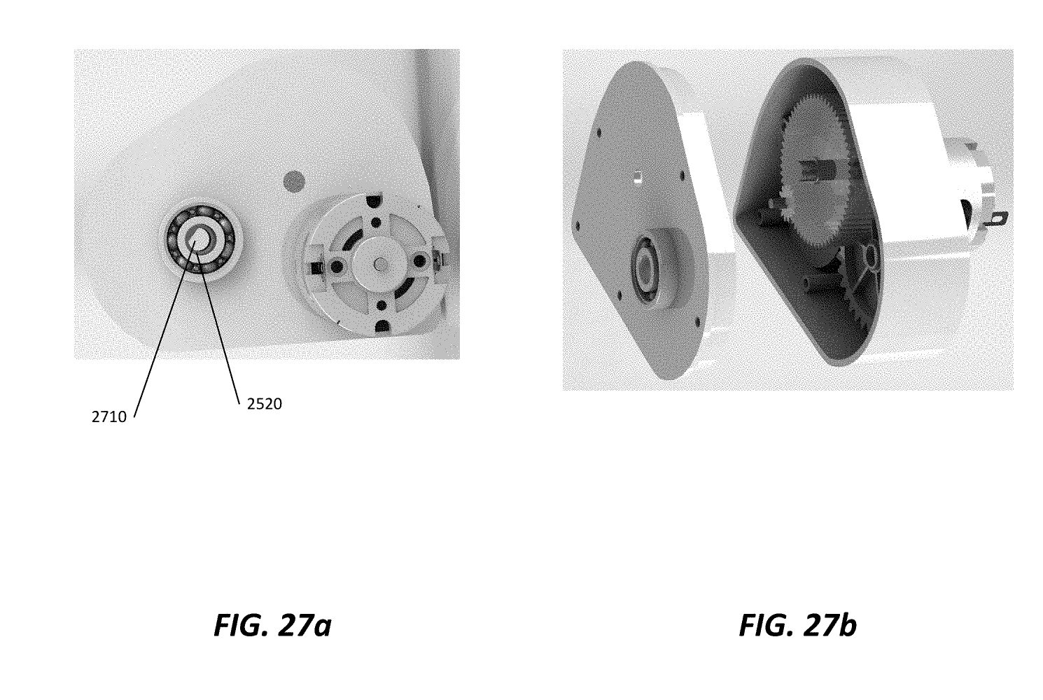

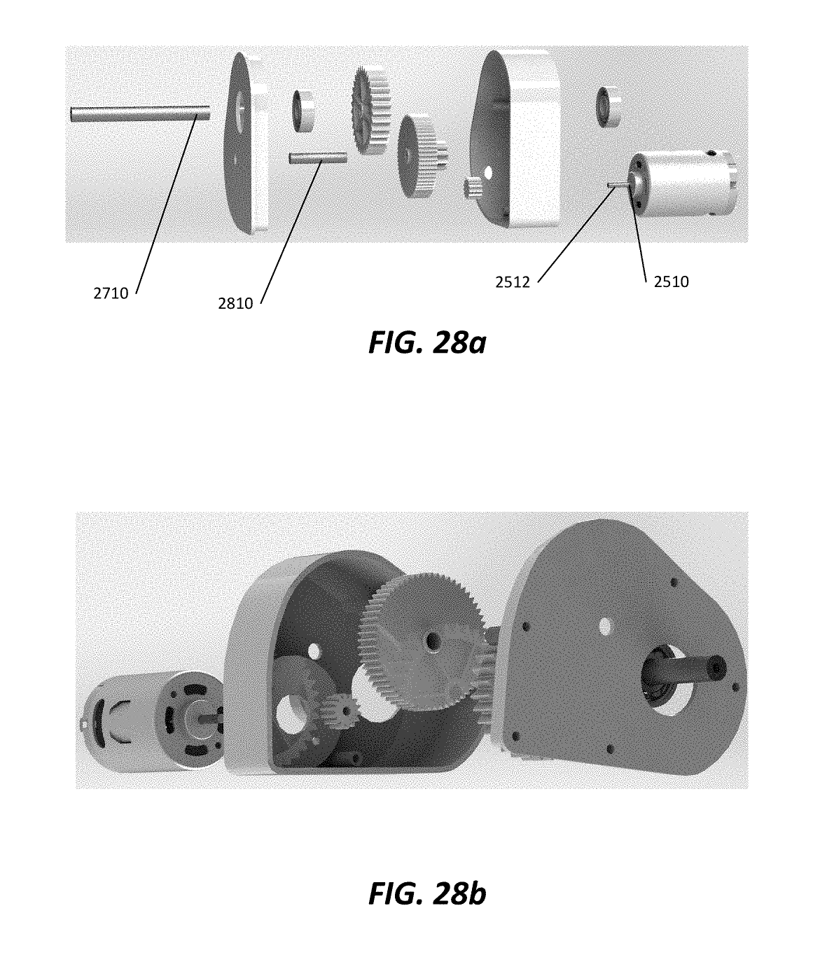

FIGS. 23 to 28 illustrate the power transmission system 2300 for transferring power from a motor 2310 to one of the omni wheels 250 so that the omni wheel 250 may rotate and move the robotic suitcase 100. There may be two such power transmission systems 2300 and motors 2310 as explained below, one for driving each of the omni wheels 250. FIG. 23 illustrates how the motor 2310, the power transmission system 2300 and the omni wheel 250 fit into the structure of the suitcase 100 near its bottom surface 410. FIGS. 24a and 24b illustrate perspective views of the motor 2310 and power transmission system 2300. FIG. 25 illustrates another perspective view of the power transmission system 2300 with the gears isolated from their casing. FIGS. 26 illustrates a side view of the power transmission system 2300 from FIG. 25 viewed from the motor side.

In one embodiment, the power transmission system 2300 comprises a motor-side inner panel 2402, a first drive shaft 2510, a drive shaft gear 2410, a first large gear 2420, a small gear 2430, a second shaft 2810, a second large gear 2440, a third shaft 2710, and a wheel-side outer panel 2404. In one embodiment, the drive shaft 2510 connects the motor to the drive shaft gear 2410.

The drive shaft 2510 may have four protrusions that may be inserted into corresponding slots in the center of the drive shaft gear 2410 to lock the drive shaft 2510 into the drive shaft gear 2410 so that they would rotate together. Thus, a motor 2310 is able to rotate the drive shaft gear 2410 by rotating the drive shaft 2510.

The drive shaft gear 2410 may interface with the first large gear 2420. The first large gear 2420 may be secured to the inner and outer panels by the second shaft 2810, which may be inserted through circular slots on the inner and outer panels as well as a circular slot in the center of the first large gear 2420. In this way, the position of the first large gear 2420 is secured relative to the inner 2402 and outer panels 2404 and may rotate around the second shaft 2810 freely.

The drive shaft gear 2410 may have a plurality of teeth around its circumference that interface with the teeth on the first large gear 2420. The teeth of the drive shaft gear 2410 may have the same pitch as the teeth of the first large gear 2420 so that the gears mesh and the first large gear 2410 may be rotated by the drive shaft gear 2410.

Because the circumference of the first large gear 2420 is greater than that of the drive shaft gear 2410, each full rotation of the drive shaft gear 2410 causes the first large gear 2420 to move a fraction of a single rotation. In one embodiment, one-hundred rotations of the drive shaft gear 2410 causes the first large gear to rotate through ten full rotations. This configuration multiples the amount of torque that the motor 2310 may apply while reducing the number rotations the motor 2310 may create with each rotation of the drive shaft 2510.

The small gear 2430 may be integrally connected to the first large gear 2420. Thus, every ten rotations of the first large gear results in a similar ten rotations of the small gear 2430. The small gear 2430 may interface with the second large gear 2440. The second large gear's 2440 position may be secured relative to the inner panel 2402 and outer panel 2404 in a similar fashion as the manner in which the first large gear 2420 is secured. A third shaft 2710 may be fitted through circular slots in the inner panel 2402 and outer panel 2404 and also through the slot 2520 at the center of the second large gear 2440. The slot 2520 may have a flat surface for locking the third shaft 2710 with the second large gear 2440 so that they would rotate together. Thus, each rotation of the second large gear 2440 causes one rotation of the third shaft 2710, which in turn connects to the omni wheels 250, causing those wheels 250 to rotate accordingly.

The small gear 2430 may have teeth that are of the same pitch as the teeth of the second large gear 2440. In one embodiment, this pitch may be different than the pitch and/or pattern as the pitch of the first large gear 2420 and the drive shaft gear 2410. In one embodiment, the circumference of the second large gear 2440 is similar to that of the first large gear 2420, both of which having a circumference that is greater than that of the small gear 2430. Consequently, it may require many rotations of the small gear 2430 against the second large gear 2440 to make one full rotation of the second large gear 2440. In one embodiment, ten rotations of the small gear 2430 causes the second large gear 2440 to rotate once.

Altogether, given this configuration of the power transmission system 2300, when the motor 2310 rotates the drive shaft gear 2410 one-hundred times, it causes the first large gear 2420 and the small gear 2430 to perform ten rotations, and the second large gear 2440, the third shaft 2710, and the omni wheel to perform one full rotation. The use of two large gears 2420 and 2440 and an intermediary small gear 2430 allows for more compact design than using a single large gear that interfaces with the drive shaft gear 2410. In one embodiment, this configuration allows the robotic suitcase 100 to move at a speed of 6.75 miles per hour or 10.86 kilometers per hour. In an alternative embodiment, the suitcase 100 may move up to 15 miles per hour. It is understood that in further embodiments, the suitcase 100 may move at a wide variety of speeds depending on its configuration.

System and Software

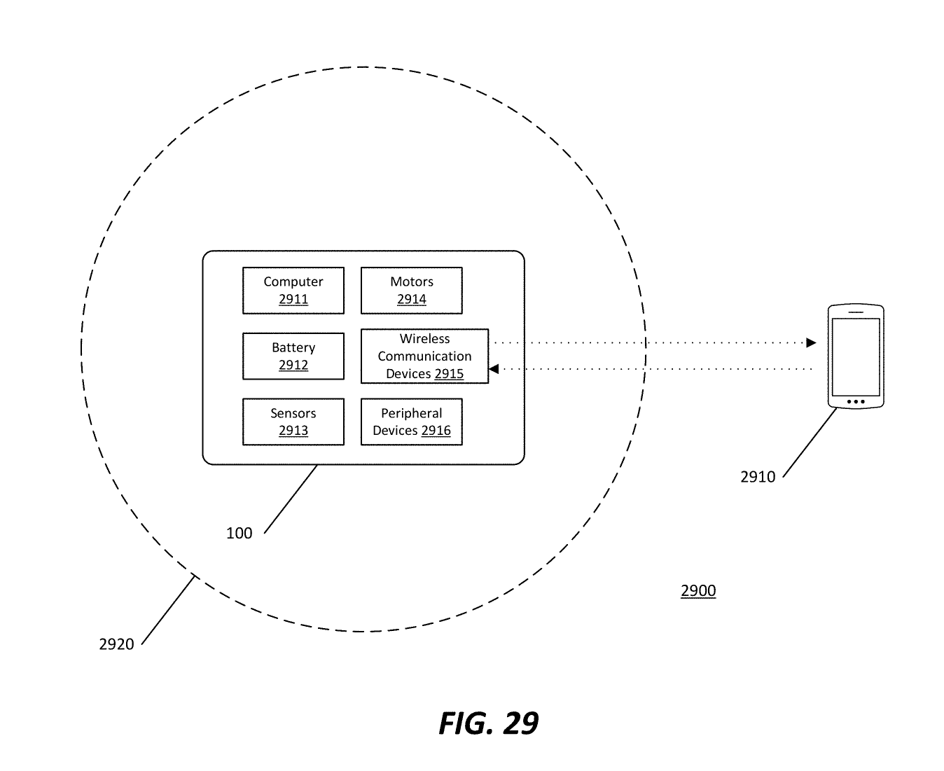

FIG. 29 illustrates an embodiment of the present technology comprising a robotic companion suitcase system 2900. The system 2900 comprises a robotic suitcase 100 and a user device 2910. The robotic suitcase 100 may be positioned within a local physical environment within the suitcase's 100 area of influence 2920. The size of the suitcase's 100 area of influence 2920 may be affected by the robot's range of motion within a short amount of time as well as the range of the robot's sensors.

The user device 2910 may be within the area of influence 2920 or outside it. For example, the user device 2910 may move far away from where the suitcase 100 is located such that the suitcase 100 may not be able to detect the user device or easily move to the device's location. Alternatively, the user device 2910 might not be too far away, but is positioned in a location that is unreachable by the suitcase 100, such as on top of a building.

In one embodiment, the suitcase 100 comprises a controller, such as a computer 2911 or other processor, a battery 2912, one or more sensors 2913, one or more motors 2914, one or more wireless communication devices 2915, and one or more peripheral devices 2916. The suitcase 100 may be communicatively connected to the user device 2910 via its wireless communication devices 2915, such as a Bluetooth device, or a Wi-Fi device.

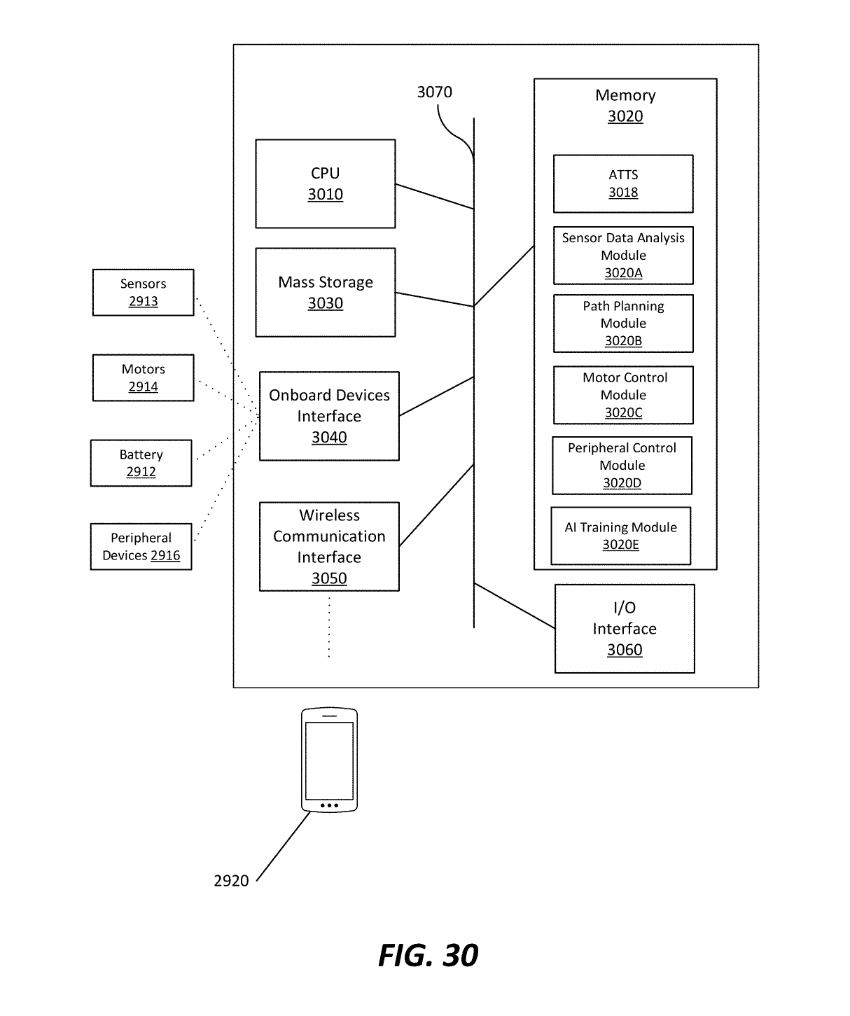

FIG. 30 illustrates an exemplary computer 2911 from FIG. 29 according to an embodiment of the present technology. The computer comprises a CPU 3010, a mass storage 3030, an onboard devices interface 3040 that is communicatively linked to the suitcase's 100 sensors 2913, motors 2914, battery 2912, and peripheral devices 2916, a wireless communication interface 3050 that is communicatively linked to the user device 2920, a memory 3020, an I/O bus 3070, and an I/O interface 3060.

In one embodiment, the memory 3020 may comprise a sensor data analysis module 3020A, a path planning module 3020B, a motor control module 3020C, a peripheral control module 3020D, and a neural net training module 3020E.

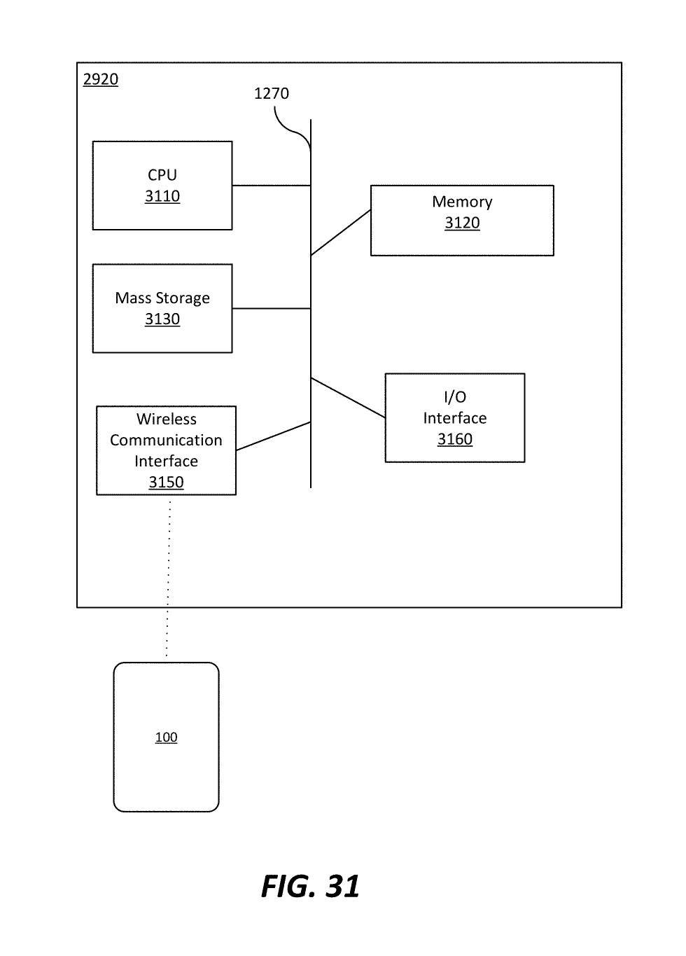

FIG. 31 illustrates an exemplary user device 2920 according to an embodiment of the present technology. The user device 2920 comprises a CPU 3110, a memory 3120, a mass storage 3130, a wireless communication interface that is communicatively linked to the robotic suitcase 100, an I/O interface, and an I/O bus 3170.

In one embodiment, the computer (or processor) 2911 controls the operation of the robotic suitcase 100 and the interaction between the suitcase 100 and the mobile device 2910. The computer (or processor 2911) may employ an autonomous target tracking control system (ATTS) 3018 (FIG. 30) for determining the target (user), following the target and determining the obstacles. The ATTS 3018 may be a multi-level software control system which includes the following subsystems:
A first subsystem for determining a user device (for example a mobile phone) of a Bluetooth device using the trilateration method and directional circular polarization antennas.
A second subsystem of visual identification and retaining the user using the human recognition feature (for example a camera module).
A third subsystem for determining the user using a variety of sensors that measure distance (for example ultrasonic, infrared sensors).
A fourth subsystem for detecting and avoiding obstacles using distance recognition sensors (for example ultrasonic, infrared sensors).
A fifth subsystem of observing the specified distance and the optimum speed.
A sixth subsystem of sound and light notification.

The first subsystem for determining a user device in general connects to the robotic suitcase using a Bluetooth protocol. The first time connecting, the user device and robotic suitcase may undergo authentication protocols to pair with each other. Thereafter, only that particular user device is considered as a trusted device. The robotic suitcase will not pair with other user devices until the user disconnects a paired user device from the robotic suitcase. After the first activation of the robotic suitcase and establishing connection, the robotic suitcase's system is calibrated. After calibration, the robotic suitcase is ready to operate. The system with very high accuracy (for example 5-15 degrees) determines the user's position and follows him, observing the set distance and the optimum speed (explained below). The first subsystem may consists of hardware (4 special directional circular polarization antennas and 4 Bluetooth Low Energy modules) and the software (mathematical algorithms and information processing from antennas) for determining and pairing with a user device. Once paired, the first subsystem determines (or causes to be determined) the angle between the user device and the robotic suitcase. In embodiments, the maximum distance at which the pairing is effective is 40m, but it may be greater or lesser than that in further embodiments.

The robotic suitcase 100 may track the user device 2920 using Bluetooth low energy modules, such as for example BLE 4.0 CC254xEMv2. The Bluetooth modules may use a variety of antenna, including for example those using SMA Antenna Minimal System Integrated Circuits with the connected and integrated directional or bipolar antennas (on the top shell of the suitcase)+camera (on the top shell of the suitcase) for the precise distance and angle calculation to the target user. The robotic suitcase 100 may follow the footsteps of the user (follow the path taken by the user device 2920). Alternatively, the robotic suitcase 100 may continuously determine and update a shortest path (a straight line in the absence of obstacles) between the user device 2920 and the robotic suitcase and follow that shortest path.

Such Bluetooth modules and antenna have a wide area of connectivity with the user device 2920, such as for example 30m in all directions. However, it may happen that the robotic suitcase 100 loses track of the user device 2920, either as a result of being out of range, or loss of power. In such an instance, the robotic suitcase 100 may send a notification to the user, either to the user device 2920 or other smart appliance (e.g. mobile phone) of the user. The notification may be sent using a mobile application associated with the operation of the robotic suitcase 100 and may be communicated by any wireless method, including text, phone call and/or email. In one example, the notification may alert the user as to the loss of tracking of the robotic suitcase, and in embodiments, the notification may guide the user to the robotic suitcase 100, for example using transmitted GPS coordinates of the robotic suitcase 100.

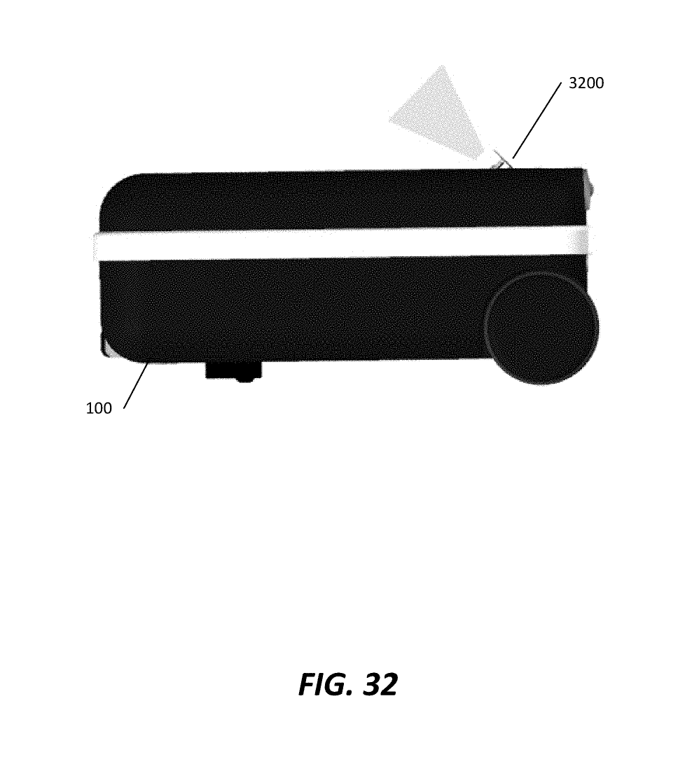

The second subsystem may consist of one camera module 3200 (FIG. 32) located at the center of the top cap of the robotic suitcase 100, at a distance of for example 25 cm from the ground and at 45° angle. The second subsystem may undergo a recognition process where a user presents themselves to the camera and the user's image and physical descriptors are captured. Thereafter, the second subsystem may facilitate tracking, but identify the user.

It is understood that camera module 3200 may also be used to capture a scene around the robotic suitcase, which can be used by the ATTS control 3018 to assist in navigation.

The third subsystem for determining the user using a variety of distance-measuring sensors may make use of 3 ultrasonic sensors located on the front of the robotic suitcase, 1 infrared sensor on the top cap (under the handle) of the robotic suitcase, 2 infrared sensors near the telescopic handle of the robotic suitcase, 2 infrared distance sensors on the right and left sides of the robotic suitcase, and 2 ultrasonic sensors and 1 infrared sensor located on the back side of the robotic suitcase. Using these sensors, the user device and/or the user may be tracked and followed.

The fourth subsystem for detecting and avoiding obstacles based on distance sensors may consists of 3 ultrasonic sensors and 1 infrared sensor located on the front of the robotic suitcase, 2 infrared sensors near the telescopic handle of the robotic suitcase, 2 infrared sensors located on the left side of the robotic suitcase, 2 infrared sensors located on the right side of the robotic suitcase (optionally a lidar located on the top cover of the product), and 2 ultrasonic sensors and 1 infrared sensor located on the back side of the robotic suitcase. These may be the same sensors or different sensors than those used in the third subsystem. If an obstacle is detected, the system informs and corrects the route that the vehicle does not interfere with the obstacle. If it's impossible to bypass an obstacle or an unavoidable obstacle (e.g., a step) is detected—it may stop and signal to alert the user.

The computer 2911 may constantly receive feedback from the variety of sensors via the fourth subsystem to detect and avoid (move around) obstacles and to navigate uneven terrain as it tracks and follows the mobile device 2910. For example, when a stationary obstacle is detected, the robotic suitcase 100 may stop and/or the sensors may detect a shortest clear path around the obstacle for the suitcase to travel in order to continue following the mobile device.

Such obstacles may include structures or objects in a path of the robotic suitcase 100, or such obstacles may include abrupt decent changes, such as an open hole. The robotic suitcase 100 may use sensors including ultrasonic sensors for sensing structures or objects in its path, and the robotic suitcase 100 may use sensors including infrared proximity sensors for sensing abrupt decent changes. When a moving obstacle is detected (for example using the ultrasonic sensors), the computer 2911 may either chart a course to avoid the moving obstacle, or cause the suitcase to stop until the moving obstacle is clear.

The fifth subsystem of observing a given distance and optimal speed. The system consists of algorithms for incoming data processing from all other subsystems, analyzing them and deciding on driving speed (including acceleration and deceleration), rotation angles, and observing the optimal distance.

The sixth subsystem of sound and light notification consists of addressable LED ribbon lights (described above), and also a speaker. Using a variety of different light patterns in the LED ribbon lights, the sixth subsystem can inform of:
turning on and off
detection of obstacles
connection breakage
entry into the turn
rotation around its axis
an attempt of stealing the robotic suitcase.
   The light ribbon may also go on when the obstacle cannot be avoided and/or once the connection with the target is lost. Various audible sounds may also be played in addition to or instead of lights to indicate one or more of the above occurrences.

The robotic suitcase may have different locomotion control modes:
Joystick
Find me
Follow me

In joystick mode, the robotic suitcase is controlled to move using the manipulator implemented in the application. There are 3 sensitivity modes of the joystick available.

In find me mode, the robotic suitcase moves in any of a variety of predefined patterns searching for the user device and/or user, for example where the robotic suitcase is more than 40 m away from the user device and/or the robotic suitcase has lost the signal. The robotic suitcase may move at a minimum speed.

In follow me mode, the robotic suitcase follows the user. To enable this mode, the user should be in a reasonable distance (e.g., 1 m) from the robotic suitcase. After the mode is turned ON, the ATTS 3018 is guided by the user via the user device. After the user is ahead of the robotic suitcase, the remaining detection systems (the second and third subsystems) are also used determine the travel of the robotic suitcase. Further on, the fourth and fifth subsystems, using the data from first, second and third subsystems, control the optimal speed with a given distance.

The computer 2911 continuously receives a signal from the mobile device 2910 to identify the position of the mobile device 2910. The computer 2911 may send locomotion signals to the motors of the respective omni wheels that cause the suitcase 100 to track and follow the mobile device 2910. The user may configure a desired spacing between the suitcase 100 and mobile device as the user moves with the mobile device. Alternatively, a default spacing may be provided. In embodiments, such a default spacing is 0.5 to 1.5 meters, but it may be smaller or larger than that in further embodiments.

In one embodiment, the sensor data analysis module 3020A, the path planning module 3020B, the motor control module 3020C, the peripheral control module 3020D, and the AI training module 3020E may all have integrated artificial intelligence elements including neural networks, such as deep neural networks and convolutional neural networks, and machine learning functionalities. These neural networks may analyze input received from the suitcase's 100 sensors 2913 to generate pathing plans and commands for controlling the suitcase's 100 movements and functionalities. The neural networks may further be trained using machine learning functionalities to improve and optimize their computation speed, accuracy, and other performance measures. A prepared set of training data may be used for optimizing the neural networks. Training data may including information directed to sensor data, pathing plans used, control commands used, and user feedback. Additional training data may be collected and aggregated from other similar suitcases. Training of the neural networks may be supervised or unsupervised.

It is understood that the robotic companion suitcase system 2900 provides a platform upon which additional functionalities may be added. In one embodiment, a user may update existing software or download additional software to the computer 2911 of the robotic suitcase 100 as well as the user device 2910, such as software directed to improved locomotion behaviors and functionality. Additional hardware components may also be added to increase the functionality of the suitcase 100, such as additional sensors, peripheral devices, and accessories.

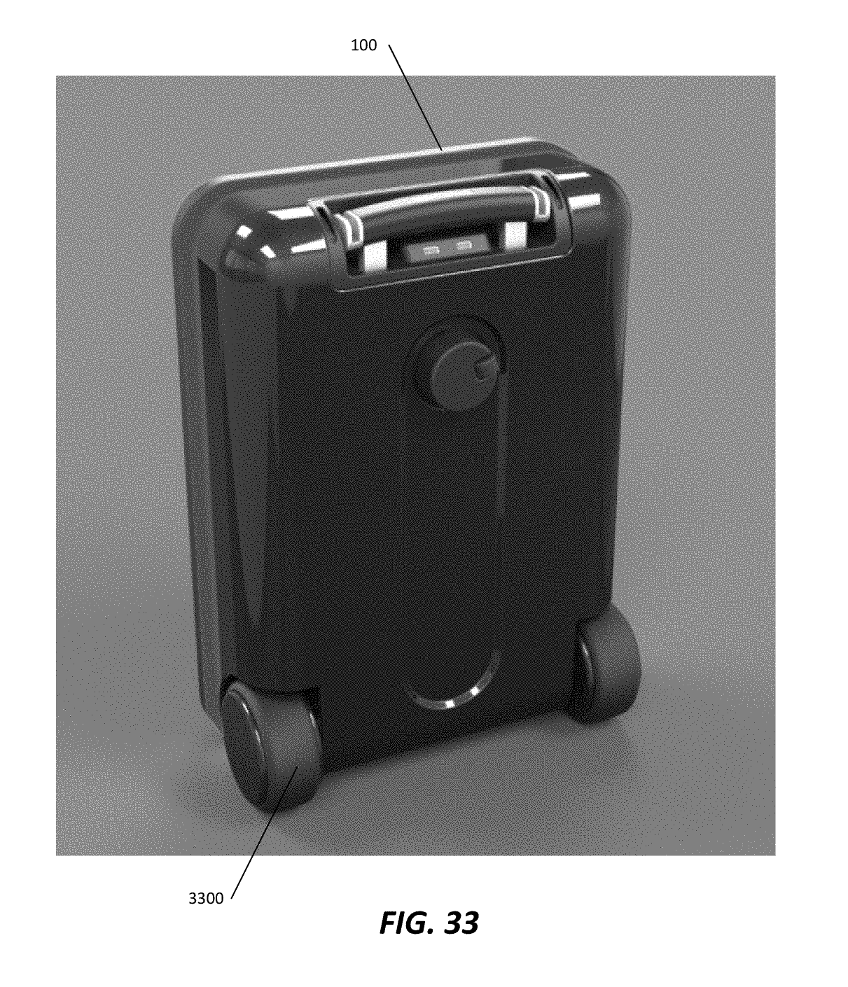

In embodiments described above, the robotic suitcase uses omni wheels 250 as shown in FIGS. 23-28. In a further embodiment, the robotic suitcase may use conventional wheel 3300, such as shown in FIG. 33. Wheels 3300 may be driven by motors 2310 as described above.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. An autonomous robotic suitcase, comprising:
a suitcase;
a motorized locomotion system within the suitcase; and
a controller configured to provide power to the motorized locomotion system enabling the suitcase to track and follow a mobile device.

2. The autonomous robotic suitcase of claim 1, further comprising a first plurality of sensors for sensing a location of the mobile device.

3. The autonomous robotic suitcase of claim 1, further comprising a second plurality of sensors for sensing obstacles in a path of the autonomous robotic suitcase.

4. The autonomous robotic suitcase of claim 3, wherein the second plurality of sensors comprise ultrasonic sensors and infrared proximity sensors.

5. The autonomous robotic suitcase of claim 3, the second plurality of sensors comprising one or more sensors for sensing objects in a path of the autonomous robotic suitcase.

6. The autonomous robotic suitcase of claim 3, the second plurality of sensors comprising one or more sensors for sensing abrupt decent changes in a terrain on which the autonomous robotic suitcase is traveling.

7. The autonomous robotic suitcase of claim 1, wherein the controller directs the locomotion system to maintain the autonomous robotic suitcase at a distance of between 0.5 and 1.5 meters from the mobile device.

8. The autonomous robotic suitcase of claim 1, wherein the controller directs the locomotion system to stop upon detecting an obstacle in a path being followed by the autonomous robotic suitcase.

9. The autonomous robotic suitcase of claim 1, wherein the controller directs the locomotion system to navigate around an obstacle upon detecting the obstacle in a path being followed by the autonomous robotic suitcase.

10. The autonomous robotic suitcase of claim 1, wherein the locomotion system comprises a pair of wheels, each powered independently by at least one motor receiving signals from the controller.

11. The autonomous robotic suitcase of claim 10, wherein the pair of wheels are configured to drive the suitcase in a first orientation where a major surface of the suitcase faces a surface on which the autonomous robotic suitcase is traveling, and the pair of wheels are configured to drive the suitcase in a second, upright orientation where the major surface of the suitcase is generally perpendicular to the surface on which the autonomous robotic suitcase is traveling.

12. The autonomous robotic suitcase of claim 11, further comprising a caster on the major surface for engaging the surface on which the autonomous robotic suitcase is traveling when in the first orientation.

13. The autonomous robotic suitcase of claim 11, further comprising a pair of rollers for engaging the surface on which the autonomous robotic suitcase is traveling when in the second, upright orientation.

14. The autonomous robotic suitcase of claim 1, further comprising LEDs on at least one surface of the autonomous robotic suitcase.

15. The autonomous robotic suitcase of claim 14, wherein the LEDs indicate at least one of a power level of a power pack for the autonomous robotic suitcase and a direction toward which the suitcase is turning.

16. A robot for transporting items within an enclosure, comprising:
a suitcase for holding the items for transport;
a motorized locomotion system within the suitcase; and
a controller, the motorized locomotion system and controller configured to have the suitcase follow a hand-held device carried by a user.

17. The robot of claim 16, further comprising one or more sensors for sensing obstacles in a path of the robot.

18. The robot of claim 17, the controller further configured to plot a path around stationary obstacles sensed in the path of the robot.

19. The robot of claim 16, wherein the locomotion system is configured to drive the suitcase in a vertical orientation and in a horizontal orientation.

20. A robotic companion suitcase system, comprising:
a mobile device; and
an autonomous robotic suitcase, comprising:
a suitcase;
a motorized locomotion system within the suitcase; and
a controller configured to provide power to the motorized locomotion system enabling the suitcase to track and follow the mobile device.

21. The autonomous robotic suitcase of claim 20, further comprising a wireless network connecting the mobile devices with the controller.

22. The autonomous robotic suitcase of claim 21, wherein the wireless network comprises a Bluetooth module.

23. The autonomous robotic suitcase of claim 20, wherein the mobile device is one of a smart phone, a tablet, a smart watch and a laptop computer.

24. The autonomous robotic suitcase of claim 20, wherein the mobile device is incorporated into an item of jewelry or clothing worn by a user.
